(19) United States
(12) Patent Application Publication
(10) Pub. No.: US 2025/0292032 A1
(43) Pub. Date: Sep. 18, 2025

(54) MACHINE LEARNING UTILIZATION SUPPORT APPARTUS, METHOD, AND STORAGE MEDIUM

(71) Applicants: KABUSHIKI KAISHA TOSHIBA, Tokyo (JP); Toshiba Digital Solutions Corporation, Saiwai-ku Kawasaki-shi (JP)

(72) Inventors: Masahiro MIYAZAKI, Yokohama Kanagawa (JP); Toshiyuki KATOU, Yokohama Kanagawa (JP); Takahiro KOZUKA, Fuchu Tokyo (JP)

(73) Assignees: KABUSHIKI KAISHA TOSHIBA, Tokyo (JP); Toshiba Digital Solutions Corporation, Saiwai-ku Kawasaki-shi (JP)

(21) Appl. No.: 19/066,333

(22) Filed: Feb. 28, 2025

(30) Foreign Application Priority Data
Mar. 15, 2024 (JP) 2024-041545

(51) Int. Cl. G06F 40/40; G06F 40/279; G06N 20/00

(52) U.S. Cl. CPC G06F 40/40; G06F 40/279; G06N 20/00

(57) ABSTRACT

According to one embodiment, a machine learning utilization support apparatus includes a database and a first processing circuit. The database stores a candidate of a machine learning task and second data having a common data format and related to a description of the candidate in association with each other in advance. The first processing circuit receives a dataset, converts each sample of the dataset to first data in the common data format, retrieves a candidate of a machine learning task associated with the second data corresponding to the first data in the database based on the first data, and generates suggestion data including a candidate of the machine learning task and a description of the candidate based on a retrieval result of the candidate.

### CROSS-REFERENCE TO RELATED APPLICATION

This application is based upon and claims the benefit of priority from Japanese Patent Application No. 2024-041545, filed Mar. 15, 2024, the entire contents of which are incorporated herein by reference.

### FIELD

Embodiments described herein relate generally to a machine learning utilization support apparatus, a method, and a storage medium.

### BACKGROUND

In recent years, the development of machine learning (ML) technology has improved the efficiency of businesses utilizing ML in various areas such as anomaly detection, appearance inspection, and document understanding. In the field of machine learning, a mechanism for determining what kind of output is returned to input data is referred to as a machine learning model or simply a model, and processing of updating the model based on the input data is referred to as training. Machine learning is roughly classified into supervised learning, unsupervised learning, and reinforcement learning based on the characteristics of the problem. When training a model, it is essential to use an appropriate learning method or algorithm according to the data or the purpose of the machine learning task. However, the development and adjustment of the model require advanced expertise and skilled technicians, and the process is burdensome in terms of time and cost.

On the other hand, automated machine learning (AutoML) has attracted attention. AutoML is a concept that automates part or all of development of an AI model. By using AutoML, even a person who does not have specialized knowledge about machine learning (non-expert of machine learning) can create a model by a simple operation. The basic operation performed by AutoML user before training the model includes three steps. The first step is to select a machine learning task based on the desired analysis. The third step is to train the model.

As described above, AutoML user selects the appropriate machine learning task for the desired analysis, uploads the data, and applies preprocessing as needed to train the model. If the user cannot select a task suitable for the data or the purpose, the user cannot obtain the desired AI model. In order to avoid such a situation, a method for supporting the selection of a machine learning task is important. For example, a method is known for supporting the selection of a machine learning task by preparing a recipe that describes preprocessing and machine learning algorithms, and enabling the retrieval of the recipe through an interactive interface.

However, according to the study by the present inventor, in the case of only providing a recipe in this method, it is difficult for a non-expert of machine learning to select an appropriate machine learning task suitable for data to be processed and a purpose, and it is difficult for the non-expert to reach an appropriate task. Specifically, when there are too many recipes, it becomes difficult for a non-expert to select an appropriate one from an enormous number available. In addition, even when the analysis purpose is determined, the machine learning task is not necessarily uniquely determined. For example, when it is desired to use a model for image anomaly detection, there are approaches of supervised learning and unsupervised learning, but a non-expert of machine learning cannot understand a difference between the two. Therefore, in the above-described method, the machine learning task cannot be appropriately selected, which hinders a non-expert of machine learning from utilizing machine learning.

Therefore, it is desirable that even a non-expert of machine learning can select an appropriate machine learning task based on data to be processed.

### BRIEF DESCRIPTION OF DRAWINGS

FIG. 1 is a block diagram illustrating an example of a configuration of the machine learning utilization support apparatus according to the first embodiment.

FIG. 2 is a flowchart for describing an operation in the first embodiment.

FIG. 3 is a block diagram illustrating an example of a configuration of the machine learning utilization support apparatus according to the second embodiment.

FIG. 4 is a schematic diagram illustrating an example of a configuration of the machine learning task database according to the second embodiment.

FIG. 5 is a sequence diagram for describing an operation in the second embodiment.

FIG. 6 is a schematic diagram for describing the operation in the second embodiment.

FIG. 7 is a schematic diagram illustrating a display example of a dataset and description in the second embodiment.

FIG. 8 is a schematic diagram illustrating an example of a configuration of a machine learning task database according to the third embodiment.

FIG. 9 is a sequence diagram for describing an operation in the third embodiment.

FIG. 10 is a schematic diagram for describing the operation in the third embodiment.

FIG. 11 is a schematic diagram for describing the operation in the fourth embodiment.

FIG. 12 is a schematic diagram for describing the operation in the fifth embodiment.

FIG. 13 is a schematic diagram illustrating an example of a configuration of the machine learning task database according to the sixth embodiment.

FIG. 14 is a sequence diagram for describing an operation in the sixth embodiment.

FIG. 15 is a schematic diagram for describing the operation in the sixth embodiment.

FIG. 16 is a schematic diagram illustrating a display example of a dataset and description in the sixth embodiment.

FIG. 17 is a schematic diagram illustrating an example of a configuration of a machine learning task database according to the seventh embodiment.

FIG. 18 is a sequence diagram for describing the operation in the seventh embodiment.

FIG. 19 is a schematic diagram illustrating an example of a retrieval prompt in the seventh embodiment.

FIG. 20 is a schematic diagram illustrating an example of a retrieval prompt in the seventh embodiment.

FIG. 21 is a schematic diagram illustrating an example of a response to a retrieval prompt in the seventh embodiment.

FIG. 22 is a schematic diagram illustrating an example of a configuration of the machine learning task database according to the eighth embodiment.

FIG. 23 is a sequence diagram for describing the operation in the eighth embodiment.

FIG. 24 is a schematic diagram illustrating an example of a summary prompt in the eighth embodiment.

FIG. 25 is a schematic diagram illustrating an example of a response to a summary prompt in the eighth embodiment.

FIG. 26 is a sequence diagram for describing the operation in the ninth embodiment.

FIG. 27 is a schematic diagram illustrating an example of a question prompt in the ninth embodiment.

FIG. 28 is a schematic diagram illustrating an example of a question prompt in the ninth embodiment.

FIG. 29 is a schematic diagram illustrating an example of a response to a question prompt in the ninth embodiment.

FIG. 30 is a block diagram illustrating an example of a configuration of the machine learning utilization system according to the tenth embodiment.

FIG. 31 is a sequence diagram for describing the operation in the tenth embodiment.

FIG. 32 is a schematic diagram illustrating a display example of an evaluation result in the tenth embodiment.

FIG. 33 is a block diagram illustrating an example of a configuration of the machine learning utilization system according to a modification of the tenth embodiment.

FIG. 34 is a block diagram illustrating an example of a hardware configuration of a machine learning utilization system according to the eleventh embodiment.

### DETAILED DESCRIPTION

In general, according to one embodiment, a machine learning utilization support apparatus includes a database and a first processing circuit. The database stores a candidate of a machine learning task and second data having a common data format and related to a description of the candidate in association with each other in advance. The first processing circuit is configured to receive a dataset to be processed of a machine learning task. The first processing circuit is configured to convert each sample of the dataset to first data in the common data format. The first processing circuit is configured to retrieve a candidate of a machine learning task associated with the second data corresponding to the first data in the database based on the first data. The first processing circuit is configured to generate suggestion data including a candidate of the machine learning task and a description of the candidate based on a retrieval result of the candidate.

Hereinafter, each embodiment will be exemplarily described with reference to the drawings.

### First Embodiment

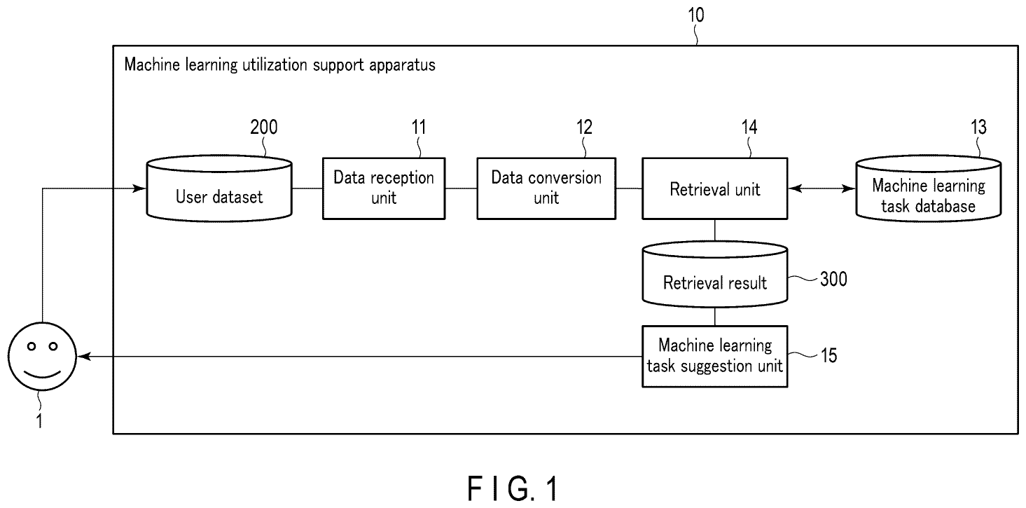

FIG. 1 is a block diagram illustrating an example of a configuration of the machine learning utilization support apparatus according to the first embodiment. A machine learning utilization support apparatus 10 includes a data reception unit 11, a data conversion unit 12, a machine learning task database 13, a retrieval unit 14, and a machine learning task suggestion unit 15.

Here, the data reception unit 11 receives a user dataset 200 uploaded by the user 1. Here, the user dataset 200 is a dataset to be processed of the machine learning task. Examples of the format of the user dataset 200 include image data, tabular (structured) data, time series data, text data, and the like, and a combination thereof may be used. Furthermore, in the related art, in the case of uploading, the directory configuration of the user dataset 200 is required to be set to an appropriate configuration according to an algorithm used for learning or a learning method (supervised, unsupervised learning, etc.). The directory configuration of the user dataset 200 of the present embodiment does not need to have a specific configuration. Note that the data reception unit 11 is an example of a reception unit.

The data conversion unit 12 converts each sample of the user dataset 200 into first data in a common data format. Examples of the common data format include text, a vector, an image, tabular data, and the like, and these may be combined to finally obtain the common data format. The data conversion unit 12 is an example of a conversion unit.

The machine learning task database 13 accumulates information of the machine learning task. For example, the machine learning task database 13 may be a relational database (RDB) that accumulates data in a table format including rows and columns, or may be a vector database that stores and manages data in a vector format. The format of the retrieval result may be a JSON format or a list format. Furthermore, for example, the machine learning task database 13 stores a candidate of the machine learning task and second data having a common data format and related to a description of the candidate in association with each other in advance. The description of the candidate preferably includes, for example, a reason why the candidate is estimated to be valid from a viewpoint of facilitating selection of the candidate by the user. The machine learning task database 13 is an example of a database and a memory.

The retrieval unit 14 selects a machine learning task having a high degree of relevance from the machine learning task database 13 in which information about the machine learning task is accumulated based on the sample (first data) converted into the common data format. For example, the retrieval unit 14 retrieves, based on the first data, a candidate of a machine learning task associated with the second data corresponding to the first data in the machine learning task database 13, and obtains a retrieval result 300. The retrieval result 300 includes at least a candidate of the machine learning task among the candidate of the machine learning task and the second data related to the description of the candidate.

The machine learning task suggestion unit 15 may present the retrieval result 300 as it is on the screen, or may sort and present a plurality of candidate in a case where a plurality of candidate of the machine learning task is included in the retrieval result 300. In any case, the machine learning task suggestion unit 15 generates suggestion data including the candidate of the machine learning task and the description of the candidate based on the retrieval result 300 of the candidate. Here, the suggestion data is screen data, and may be displayed on a display unit (not illustrated) or may be transmitted to a user terminal (not illustrated). The machine learning task suggestion unit 15 is an example of a suggestion unit.

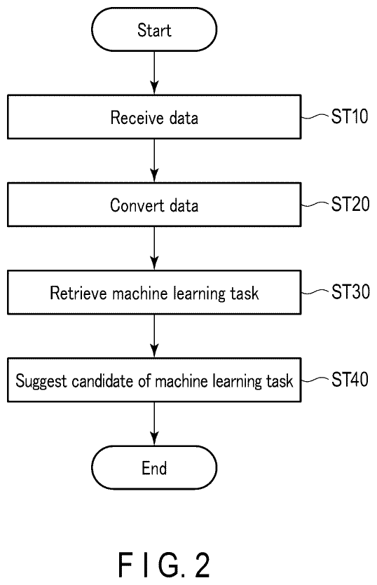

Next, the operation of the information processing apparatus configured as described above will be described with reference to the flowchart of FIG. 2.

Now, in step ST10, the data reception unit 11 receives the user dataset 200 uploaded by the user 1.

After step ST10, in step ST20, the data conversion unit 12 converts each sample of the user dataset 200 into first data in a common data format.

After step ST20, in step ST30, the retrieval unit 14 retrieves a candidate of the machine learning task associated with the second data corresponding to the first data in the machine learning task database 13 based on the first data in the common data format.

After step ST30, in step ST40, the machine learning task suggestion unit 15 generates suggestion data including a candidate of the machine learning task and the description of the candidate based on the candidate retrieval result 300. Thereafter, the machine learning task suggestion unit 15 suggests the candidate of the machine learning task together with the description, for example, by displaying the suggestion data on a display unit (not illustrated).

As a result, the user 1 selects an appropriate machine learning task based on the suggestion content.

As described above, according to the first embodiment, the data reception unit 11 receives the dataset to be processed of the machine learning task. The data conversion unit 12 converts each sample of the dataset into first data in a common data format. The machine learning task database 13 stores the candidate of the machine learning task and the second data having the common data format and related to the description of the candidate in association with each other in advance. The retrieval unit 14 retrieves, based on the first data, a candidate of a machine learning task associated with the second data corresponding to the first data in the machine learning task database 13. The machine learning task suggestion unit 15 generates suggestion data including a candidate of the machine learning task and the description of the candidate based on a retrieval result of the candidate. As described above, with the configuration in which the original data is converted into the common data format and can be retrieved, and the candidate of the machine learning task and the description thereof are suggested based on the retrieval result, even a non-expert of machine learning can select an appropriate machine learning task based on the data to be processed.

### Second Embodiment

Next, a machine learning utilization support apparatus according to the second embodiment will be described.

The second embodiment is a specific example of the first embodiment, and is an example of a case where the common data format is a text format and the suggestion data is displayed on the display unit.

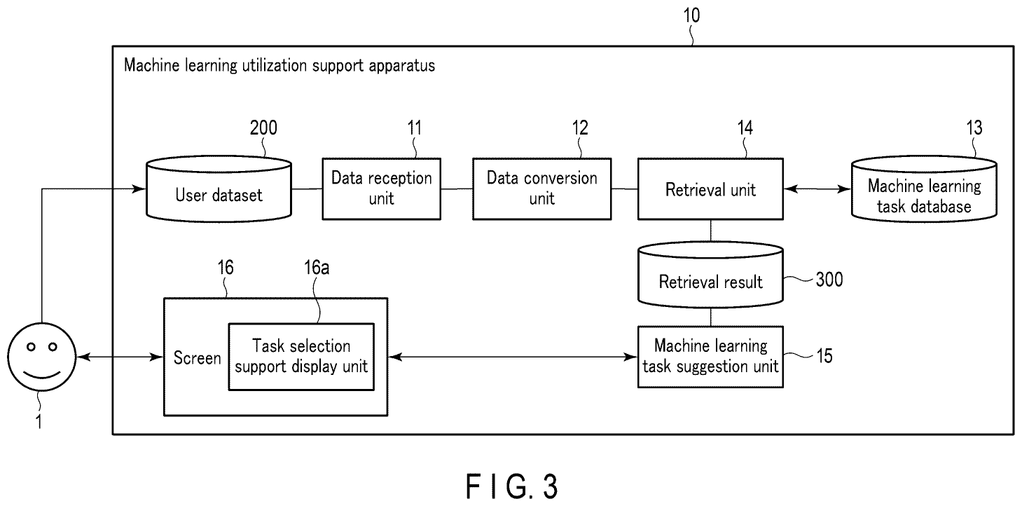

FIG. 3 is a block diagram illustrating an example of a configuration of the machine learning utilization support apparatus according to the second embodiment, in which substantially the same parts as those in FIG. 1 are denoted by the same reference numerals and detailed description thereof is omitted, and here, different parts will be mainly described. In the following embodiments, the description of overlapping parts is similarly omitted. The machine learning utilization support apparatus 10 further includes a display unit 16 that displays a screen including a task selection support display unit 16a, as compared with the configuration illustrated in FIG. 1.

Here, the display unit 16 displays a candidate of the machine learning task included in the suggestion data and the description of the candidate. The display unit 16 is an example of a display.

The task selection support display unit 16a is a display unit related to the candidate of the machine learning task included in the suggestion data and the description of the candidate. The task selection support display unit 16a may display only machine learning tasks having a high degree of relevance, may sort by the degree of relevance, and may highlight a machine learning task having a high degree of relevance. In addition, the task selection support display unit 16a may include a graphical user interface (GUI) that receives a user's operation in addition to the display area related to the description of the candidate. Here, as the user's operation, for example, any operation related to task selection such as an operation of selecting a machine learning task and an operation of making a question can be used.

Furthermore, since the common data format is the text format, the data conversion unit 12 has the function of performing caption generation (captioning) and word counting in addition to the functions described above. As a method of performing the captioning, a caption-generating AI created by the data conversion unit may be used, or a public model of the caption-generating AI may be used. For example, a large-scale language model (LLM) distributed in an open source or a language model that can be used from an API in a cloud service may be used. Fine tuning in which the model is finely adjusted according to the task may be performed. The captioning language may be Japanese or another language. In order to perform the captioning, the language input by the user may be changed to a common language different from the input, and the output may be translated according to the language of the user. As a method of performing word counting, a keyword may be determined in advance, and the number of appearances of a word (keyword) included in the caption may be counted according to the keyword. Alternatively, when word counting is performed, a technical term may be extracted by natural language processing, and the number of appearances of a word (keyword) included in the caption may be counted.

In any case, the data conversion unit 12 generates a caption describing each sample of the user dataset 200 in a text format, counts the number of appearances of words included in the caption, and sets a word having a relatively large number of appearances as the first data.

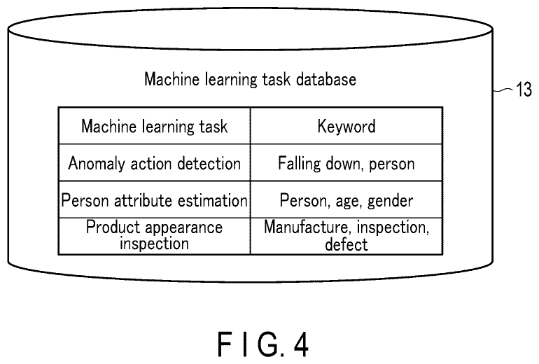

As illustrated in FIG. 4, the machine learning task database 13 stores a candidate of the machine learning task and a keyword (second data) having a common data format and related to the description of the candidate in association with each other in advance. Here, the second data is a candidate keyword.

The retrieval unit 14 retrieves the candidate of the machine learning task from the machine learning task database 13 by keyword retrieval based on the word that is the first data. Note that the present invention is not limited thereto, and the retrieval unit 14 may aggregate the number of matches between the word as the first data and the keyword to retrieve the candidate of the machine learning task associated with the second data using the keyword having a relatively large number of matches as the second data.

Other configurations are the same as those of the first embodiment.

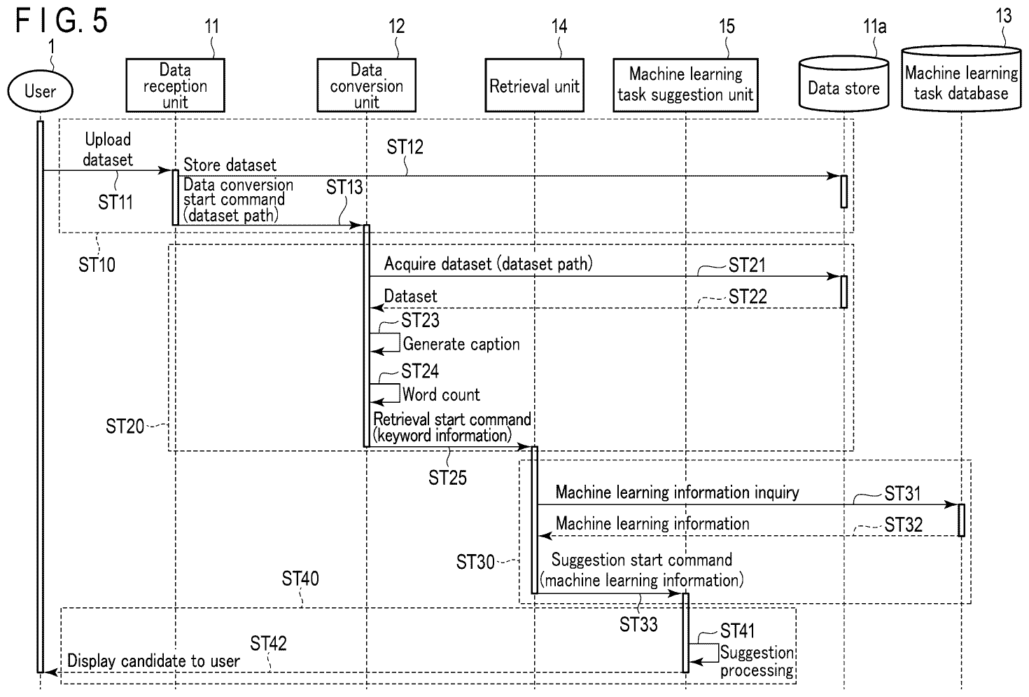

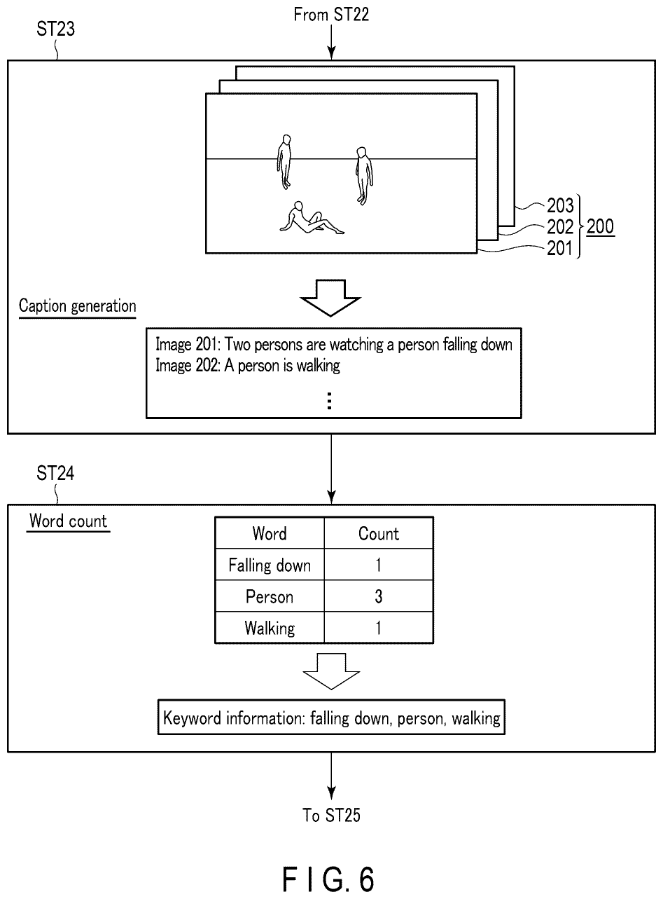

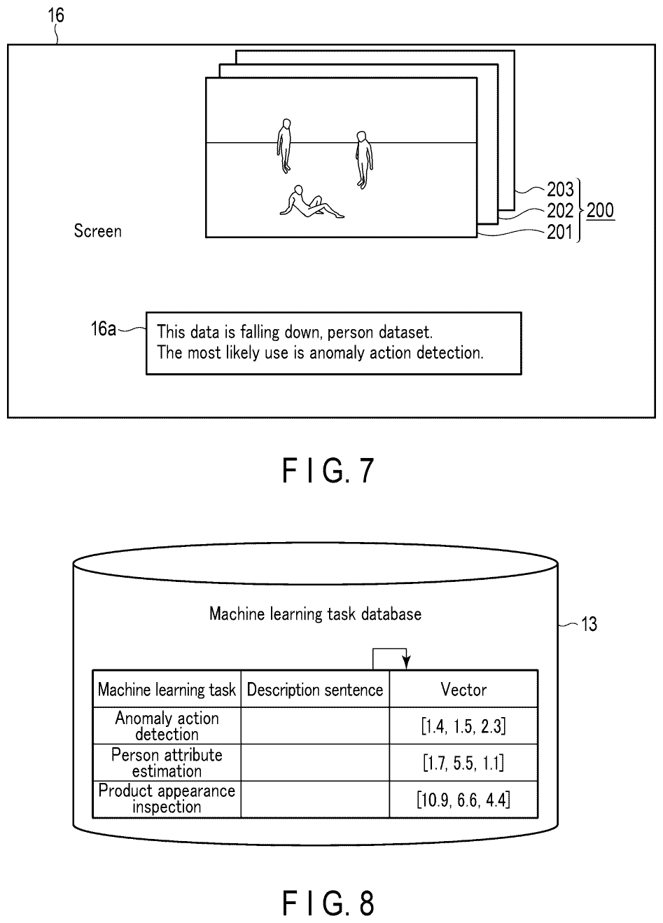

Next, the operation of the machine learning utilization support apparatus configured as described above will be described with reference to the sequence diagram of FIG. 5 and the schematic diagrams of FIGS. 6 and 7. In the following description, steps ST10 to ST40 described above will be described using more detailed steps.

### (Step ST10)

Now, the data reception unit 11 receives the user dataset 200 uploaded by a user 1 (step ST11). The data reception unit 11 stores the received user dataset 200 in a data store 11a (step ST12). Thereafter, the data reception unit 11 transmits a data conversion start command including the dataset path to the data conversion unit 12 (step ST13). Accordingly, step ST10 ends.

### (Step ST20)

Upon receiving the data conversion start command, the data conversion unit 12 acquires the user dataset 200 from the data store 11a based on the dataset path extracted from the data conversion start command (steps ST21 to ST22).

After step ST22, the data conversion unit 12 generates a caption describing each sample of the acquired user dataset 200 in a text format (step ST23). For example, as illustrated in FIG. 6, the data conversion unit 12 generates a caption “two persons are watching a person falling down” from an image 201 of each sample, and generates a caption “a person is walking” from an image 202 of each sample.

After step ST23, the data conversion unit 12 counts the number of appearances of words included in the caption, and sets a word having a relatively large number of appearances as the first data (step ST24). For example, the data conversion unit 12 counts the number of appearances of the words “falling down”, “person”, and “walking” included in the caption, and sets the words “falling down”, “person”, and “walking” having a relatively large number of appearances as the first data. The first data is used for retrieval as keyword information.

After step ST24, the data conversion unit 12 transmits a retrieval start command including the keyword information “falling down”, “person”, and “walking” to the retrieval unit 14 (step ST25). Accordingly, step ST20 ends.

### (Step ST30)

Upon receiving the retrieval start command, the retrieval unit 14 performs keyword retrieval by transmitting a machine learning information inquiry including the keyword information “falling down”, “person”, and “walking” extracted from the retrieval start command to the machine learning task database 13 (step ST31).

After step ST31, the retrieval unit 14 receives the machine learning information including the retrieval result 300 of the candidate of the machine learning task and the keyword information from the machine learning task database 13 (step ST32). Note that the machine learning information received in step ST32 does not necessarily include the keyword information. In this case, the retrieval unit 14 can acquire the machine learning information including the candidate retrieval result 300 and the keyword information by including the keyword information extracted from the retrieval start command in the machine learning information.

In any case, after step ST32, the retrieval unit 14 transmits a suggestion start command including the machine learning information including the candidate retrieval result 300 and the keyword information to the machine learning task suggestion unit 15 (step ST33). Accordingly, step ST30 ends.

### (Step ST40)

Upon receiving the suggestion start command, the machine learning task suggestion unit 15 executes suggestion processing based on the machine learning information extracted from the suggestion start command (step ST41). The suggestion processing is, for example, a process of generating suggestion data including a candidate of the machine learning task and the description of the candidate based on the retrieval result 300 of the candidate of the machine learning task included in the machine learning information and the keyword information.

After step ST41, for example, as illustrated in FIG. 7, the machine learning task suggestion unit 15 displays the task selection support display unit 16a based on the suggestion data and the user dataset 200 on the display unit 16 to suggest the candidate of the machine learning task together with the description. As a result, the user 1 selects an appropriate machine learning task based on the suggestion content.

As described above, according to the second embodiment, the display unit 16 displays the candidate of the machine learning task included in the suggestion data and the description of the candidate. Therefore, in addition to the effects described above, the display by the display unit 16 can prompt the user 1 to select a candidate of the machine learning task.

Further, according to the second embodiment, the common data format is a text format, and the second data is a candidate keyword. The data conversion unit 12 generates a caption describing each sample of the user dataset 200 in a text format, counts the number of appearances of words included in the caption, and sets a word having a relatively large number of appearances as the first data. The retrieval unit 14 retrieves the candidate of the machine learning task from the machine learning task database 13 by keyword retrieval based on the word that is the first data. Therefore, in addition to the effects described above, the machine learning task can be suggested to the user according to the keyword registered in advance in the machine learning task database 13.

### Third Embodiment

Next, a machine learning utilization support apparatus according to the third embodiment will be described.

The third embodiment is a modification of the first or second embodiment, and is an example of a case where the common data format is a vector format.

Accordingly, in addition to the above-described functions, the data conversion unit 12 converts each sample of the user dataset 200 into the first fixed length vector that is the first data. To supplement, the user dataset 200 is a set of image data. The data conversion unit 12 generates a caption describing each sample of the user dataset 200 in a text format, and converts the caption into a first fixed length vector.

As illustrated in FIG. 8, the machine learning task database 13 stores a candidate of the machine learning task and a vector (second data) having a common data format and related to a description sentence of the candidate in association with each other in advance. Here, the second data is a second fixed length vector obtained by converting the candidate description sentence.

The retrieval unit 14 retrieves a candidate of the machine learning task by vector similarity retrieval between the first fixed length vector and the second fixed length vector.

Other configurations are the same as those of the second embodiment.

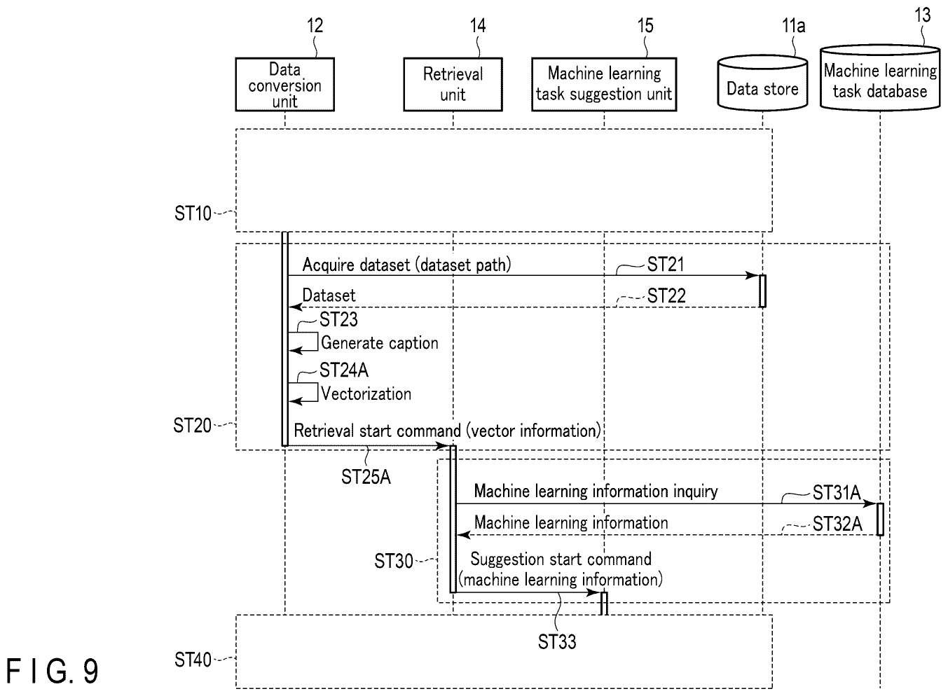

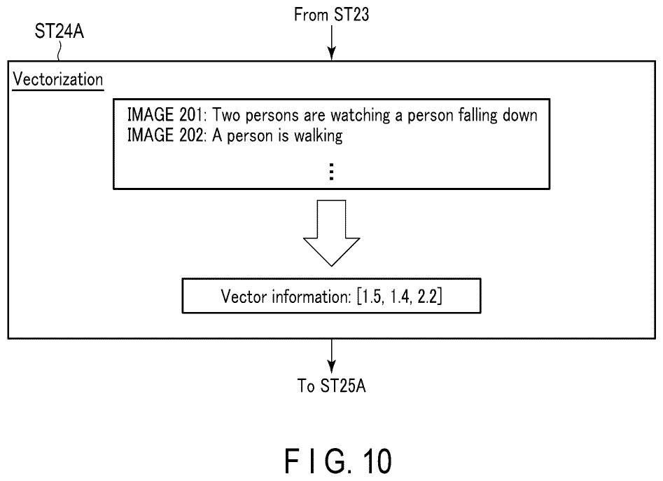

Next, the operation of the machine learning utilization support apparatus configured as described above will be described using the sequence diagram of FIG. 9 and the schematic diagram of FIG. 10. In the following description, among steps ST10 to ST40 described above, steps ST20 to ST30 different from those in the second embodiment will be described using more detailed steps.

Now, step ST10 is executed in the same manner as described above.

### (Step ST20)

Steps ST21 to ST23 are executed in the same manner as described above, and the caption describing each sample of the user dataset 200 in a text format are generated.

After step ST23, the data conversion unit 12 vectorizes the caption as illustrated in FIG. 10 (step ST24A), and converts the caption into a first fixed length vector (first data). The first data is used for retrieval as vector information.

As a method of performing the vectorization, a technique of converting the caption into a vector from the importance of the word in the sentence or a deep learning based technique may be used. For each sample of the user dataset 200 in the data conversion unit 12, all the images of the user dataset 200 may be used, or part of the data may be used.

After step ST24A, the data conversion unit 12 transmits a retrieval start command including the vector information [1.4, 1.5, 2.3] to the retrieval unit 14 (step ST25A). Accordingly, step ST20 ends.

### (Step ST30)

Upon receiving the retrieval start command, the retrieval unit 14 performs vector retrieval by transmitting a machine learning information inquiry including the vector information [1.4, 1.5, 2.3] extracted from the retrieval start command to the machine learning task database 13 (step ST31A). As a method of performing vector retrieval, cosine similarity that measures similarity by calculating a cosine of an angle between vectors may be used, a Euclidean distance (L2 distance) between vectors may be used, a Manhattan distance (L1 distance) between vectors may be used, or a Mahalanobis distance that is a distance measure in consideration of a covariance and in consideration of a correlation coefficient of a feature may be used. The machine learning task database 13 may generate the caption of datasets prepared in advance in the RDB and register data converted into the vector or may use a vector database.

After step ST31A, the retrieval unit 14 receives the machine learning information including the retrieval result 300 of the candidate of the machine learning task and the description sentence of the candidate from the machine learning task database 13 (step ST32A).

After step ST32A, the retrieval unit 14 transmits a suggestion start command including the machine learning information including the candidate retrieval result 300 and the candidate description sentence to the machine learning task suggestion unit 15 (step ST33). Accordingly, step ST30 ends.

Thereafter, step ST40 is executed in the same manner as described above.

As described above, according to the third embodiment, the common data format is a vector format. The data conversion unit 12 converts each sample of the user dataset 200 into a first fixed length vector that is first data. The second data is a second fixed length vector obtained by converting the description of the candidate. The retrieval unit 14 retrieves a candidate of the machine learning task by vector similarity retrieval between the first fixed length vector and the second fixed length vector. Therefore, even when the common data format is the vector format, the above-described effect can be obtained.

In addition, according to the third embodiment, the user dataset 200 is a set of image data. The data conversion unit 12 generates a caption describing each sample of the user dataset 200 in a text format, and converts the caption into a first fixed length vector. Therefore, in addition to the effects described above, the vector retrieval can be performed on the image dataset to perform retrieval at high speed, and it is possible to suggest the candidate of the machine information task from information more than that in the second embodiment. That is, it is possible to suggest a machine learning task closer to the thought of a machine learning expert to the user.

### Fourth Embodiment

Next, a machine learning utilization support apparatus according to the fourth embodiment will be described.

The fourth embodiment is a modification of the third embodiment, and is an example of a case where the user dataset 200 is a set of tabular data.

Accordingly, in addition to the functions described above, the data conversion unit 12 generates a caption that describes the feature of the user dataset 200 in text format based on the file name, the header character string, and the statistic of each column of each sample of the user dataset 200, and converts the caption into the first fixed length vector.

Other configurations are the same as those of the third embodiment.

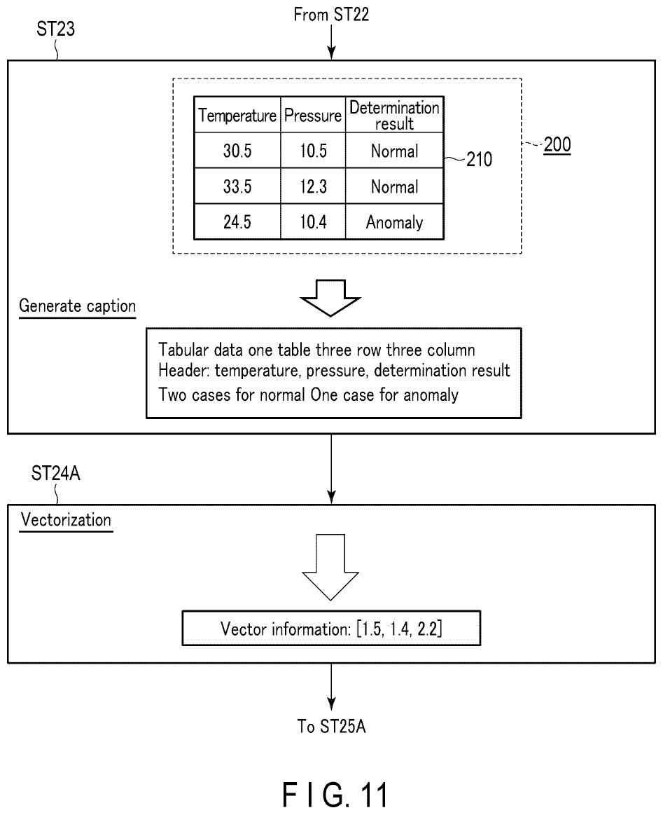

According to the above configuration, in step ST23 of step ST20 described above, as illustrated in FIG. 11, the data conversion unit 12 generates a caption describing tabular data 210 that is each sample of the user dataset 200 in a text format. For example, the data conversion unit 12 generates a caption that describes the feature of the user dataset 200 in text format based on the file name, the header character string “temperature”, “pressure”, and “determination result”, and the statistic of each column “two cases for normal, one case for anomaly” of the tabular data 210.

The caption generation performed by the data conversion unit 12 may be caption generation by a rule-based algorithm or may cause the LLM to describe the feature of the dataset. As the statistic of each column, an average value, a median value, maximum and minimum values, a variance, a standard deviation, or the like may be used. As the header character string, the column name may be used as it is or a character string similar to the character string of the header may be included. When there is a classification item in the tabular data, the number of data belonging to the classification item may be counted.

After step ST23, the data conversion unit 12 vectorizes the caption (step ST24A) and converts the caption into a first fixed length vector (first data). The first data is used for retrieval as vector information.

Hereinafter, the processing in and after step ST25A is executed in the same manner as described above.

As described above, according to the fourth embodiment, the user dataset 200 is a set of tabular data. The data conversion unit 12 generates a caption that describes the feature of the user dataset 200 in a text format based on the file name, the header character string, and the statistic of each column of each sample of the user dataset 200, and converts the caption into a first fixed length vector. Therefore, in addition to the effects described above, it is possible to perform a high-speed retrieval by performing vector retrieval on the table dataset, and it is possible to suggest the candidate of the machine learning task from information more than that in the second embodiment. That is, it is possible to suggest a machine learning task closer to the thought of a machine learning expert to the user.

### Fifth Embodiment

Next, a machine learning utilization support apparatus according to the fifth embodiment will be described.

The fifth embodiment is a modification of the third embodiment, and is an example of a case where the user dataset 200 is a set of time series data.

Accordingly, in addition to the functions described above, the data conversion unit 12 generates a caption that describes the feature of the user dataset 200 in text format based on the file name, the series name, and the statistic for each series of each sample of the user dataset 200, and converts the caption into the first fixed length vector.

Other configurations are the same as those of the third embodiment.

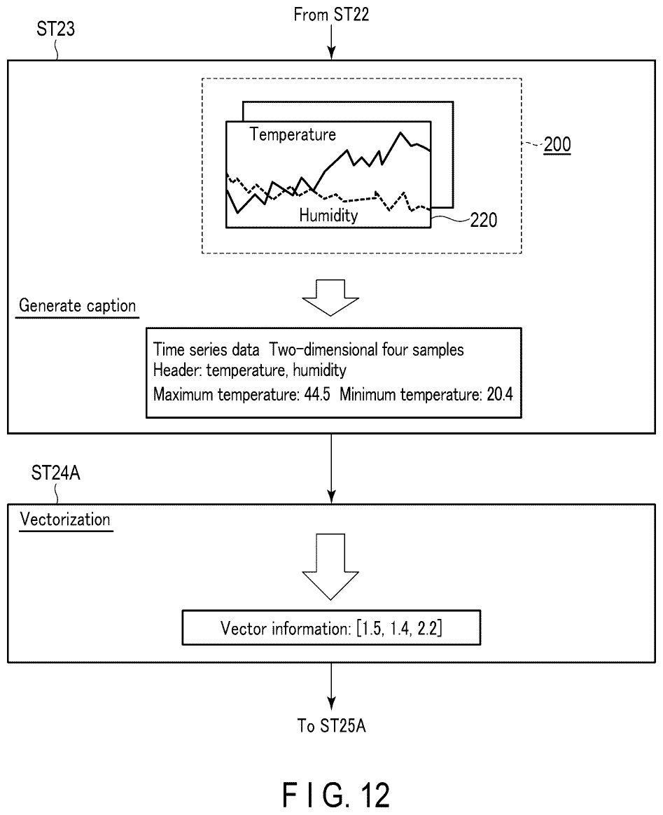

According to the above configuration, in step ST23 of step ST20 described above, the data conversion unit 12 generates a caption describing time series data 220 that is each sample of the user dataset 200 in a text format as illustrated in FIG. 12. For example, the data conversion unit 12 generates a caption that describes the feature of the user dataset 200 in text format based on the file name, the series name “temperature”, “humidity”, and the statistic for each series “maximum temperature 44.5° C., minimum temperature 20.4° C.” of the time series data 220.

The caption generation performed by the data conversion unit 12 may be caption generation by a rule-based algorithm or may cause the LLM to describe the feature of the dataset. As the statistic of each column, an average value, a median value, maximum and minimum values, a variance, a standard deviation, or the like may be used, or a change amount at regular time intervals may be used.

After step ST23, the data conversion unit 12 vectorizes the caption (step ST24A) and converts the caption into a first fixed length vector (first data). The first data is used for retrieval as vector information.

Hereinafter, the processing in and after step ST25A is executed in the same manner as described above.

As described above, according to the fourth embodiment, the user dataset 200 is a set of time series data. The data conversion unit 12 generates a caption that describes the feature of the user dataset 200 in a text format based on the file name, the series name, and the statistic for each series of each sample of the user dataset 200, and converts the caption into a first fixed length vector. Therefore, in addition to the effects described above, it is possible to perform a high-speed retrieval by performing vector retrieval on the time series dataset, and it is possible to suggest the candidate of the machine learning task from information more than that in the second embodiment. That is, it is possible to suggest a machine learning task closer to the thought of a machine learning expert to the user.

### Modifications of Fourth and Fifth Embodiments

In the fourth embodiment, the case where the user dataset 200 is a set of tabular data is described, but the present invention is not limited thereto. Similarly, in the fifth embodiment, the case where the user dataset 200 is a set of time series data is described, but the present invention is not limited thereto. That is, the user dataset 200 may be a set of multimodal data including tabular data and time series data. In this case, the data conversion unit 12 generates a caption describing the feature of the user dataset 200 in a text format based on the file name, the data format, and the header character string included in the dataset, and converts the caption into the first fixed length vector. According to such a modification, the effect of the fourth embodiment and the effect of the fifth embodiment can be simultaneously obtained for one user dataset 200.

### Sixth Embodiment

Next, the machine learning utilization support apparatus according to the sixth embodiment will be described.

The sixth embodiment is a modification of the first or second embodiment, and is an example of a case where the common data format is a vector format.

Accordingly, in addition to the functions described above, the data conversion unit 12 converts each sample of the user dataset 200 into a first fixed length vector that is first data, and estimates the first domain of the user dataset 200 based on the first fixed length vector. In the domain estimation, a model trained to estimate a domain from a vector in advance may be used, or a publicly available model may be used. The model for estimating the domain may be the LLM, may be supervised trained by deep learning, or may be a model that has learned the distance of the vector by deep distance learning. When the candidate is displayed to the user, the selected domain information may be displayed in text or may not be displayed.

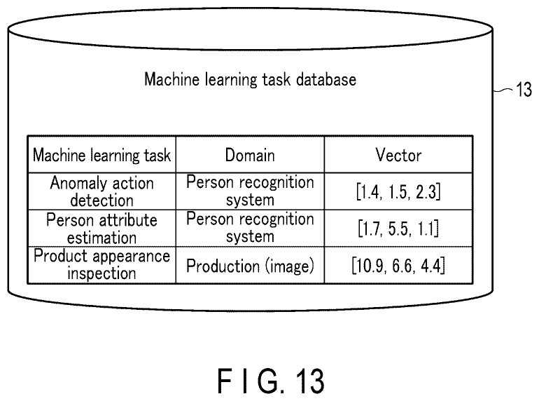

As illustrated in FIG. 13, the machine learning task database 13 stores a candidate of the machine learning task, a vector (second data) having a common data format and related to the description of the candidate, and a second domain of the candidate in association with each other in advance. Here, the second data is a second fixed length vector obtained by converting the description of the candidate (not illustrated). The candidate second domain also functions as the description of the candidate.

The retrieval unit 14 retrieves a candidate of the machine learning task based on the first domain and the first fixed length vector.

Other configurations are the same as those of the second embodiment.

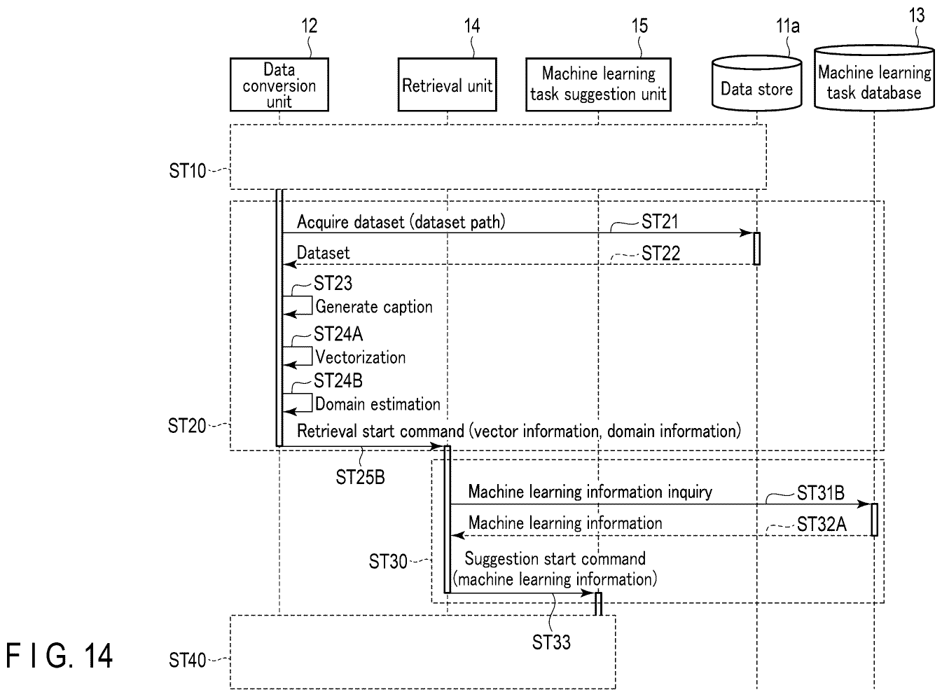

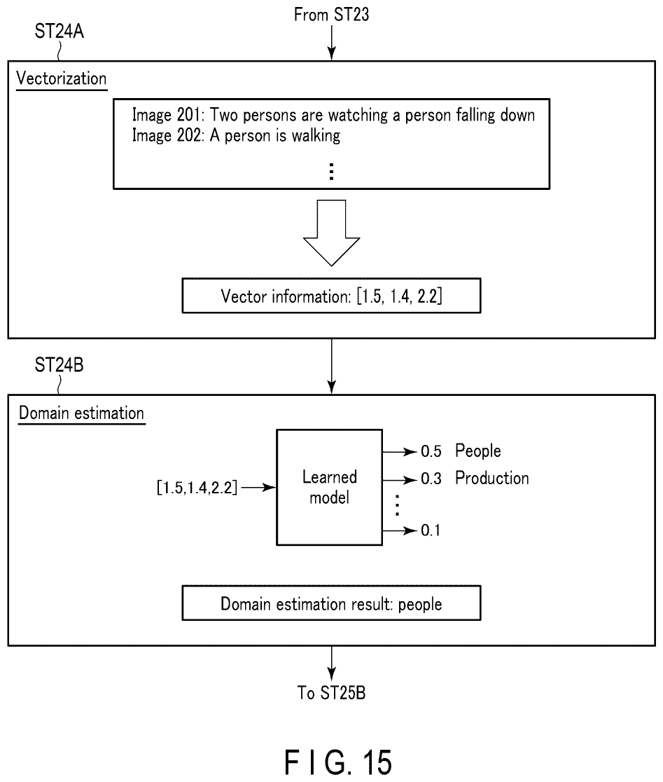

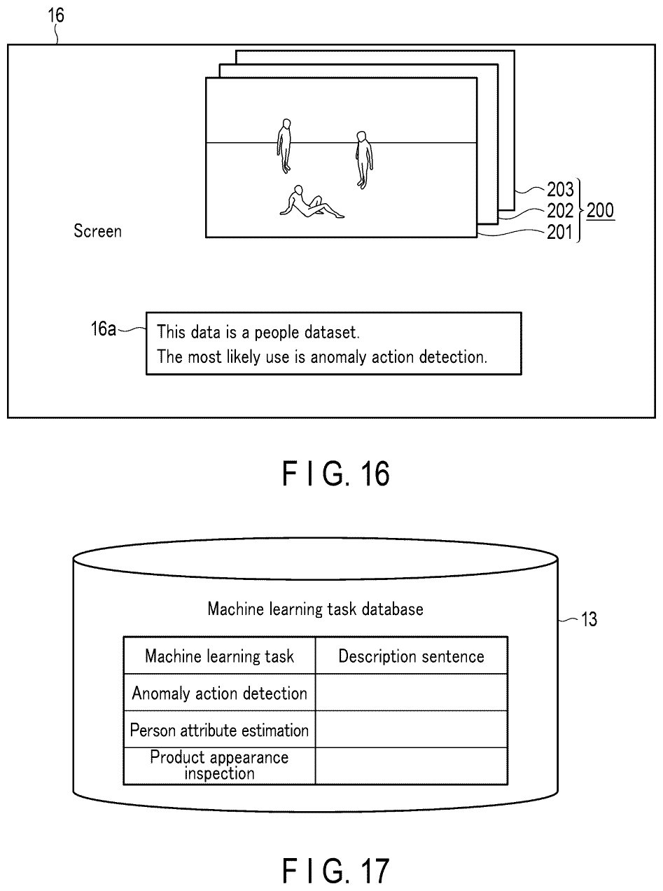

Next, the operation of the machine learning utilization support apparatus configured as described above will be described with reference to the sequence diagram of FIG. 14 and the schematic diagrams of FIGS. 15 and 16. In the following description, among steps ST10 to ST40 described above, steps ST20 to ST30 different from those in the second embodiment will be described using more detailed steps.

Now, step ST10 is executed in the same manner as described above.

### (Step ST20)

Steps ST21 to ST23 are executed in the same manner as described above, and the caption describing each sample of the user dataset 200 in a text format are generated.

After step ST23, as illustrated in FIG. 15 (step ST24A), the data conversion unit 12 vectorizes the caption, and converts the caption into a first fixed length vector (first data). The first data is used for domain estimation and retrieval as vector information [1.5, 1.4, 2.2].

After step ST24A, the data conversion unit 12 estimates the first domain “people” of the user dataset 200 using the learned model based on the vector information [1.5, 1.4, 2.2](step ST24B). The first domain is used for retrieval as domain information “people”.

After step ST24B, the data conversion unit 12 transmits a retrieval start command including the vector information [1.4, 1.5, 2.3] and the domain information “people” to the retrieval unit 14 (step ST25B). Accordingly, step ST20 ends.

### (Step ST30)

Upon receiving the retrieval start command, the retrieval unit 14 transmits a machine learning information inquiry including the vector information [1.4, 1.5, 2.3] and the domain information “people” extracted from the retrieval start command to the machine learning task database 13 to perform vector retrieval filtered by people (step ST31B).

After step ST31B, the retrieval unit 14 receives the machine learning information including the retrieval result 300 of the candidate of the machine learning task from the machine learning task database 13 (step ST32A).

After step ST32A, the retrieval unit 14 transmits a suggestion start command including the machine learning information including the retrieval result 300 of the candidate and the domain information “people” serving as the description of the candidate to the machine learning task suggestion unit 15 (step ST33). Accordingly, step ST30 ends.

Thereafter, step ST40 is executed in the same manner as described above. For example, as illustrated in FIG. 16, the machine learning task suggestion unit 15 displays, on the display unit 16, the task selection support display unit 16a based on suggestion data including a retrieval result 300 of the candidate and domain information “people” serving as a description of the candidate, and the user dataset 200. The user 1 selects an appropriate machine learning task based on the displayed suggestion content.

As described above, according to the sixth embodiment, the common data format is vector data. The data conversion unit 12 converts each sample of the user dataset 200 into a first fixed length vector that is first data, and estimates a first domain of the user dataset 200 based on the first fixed length vector. The machine learning task database 13 stores the candidate of the machine learning task, the second domain of the candidate, and the second data in association with each other. The second data is a second fixed length vector obtained by converting the description of the candidate. The retrieval unit 14 retrieves a candidate of the machine learning task based on the first domain and the first fixed length vector. Therefore, in addition to the effects described above, it is possible to narrow the range of selection by the user by narrowing the domains. That is, the user having a narrower selection range can select the machine learning task more easily than the first to fifth embodiments.

### Seventh Embodiment

Next, the machine learning utilization support apparatus according to the seventh embodiment will be described.

The seventh embodiment is a modification of the second embodiment, and is an example of a case where retrieval is performed using a retrieval prompt.

Here, the common data format is a text format.

The data conversion unit 12 generates a caption describing each sample of the user dataset 200 in a text format as the first data.

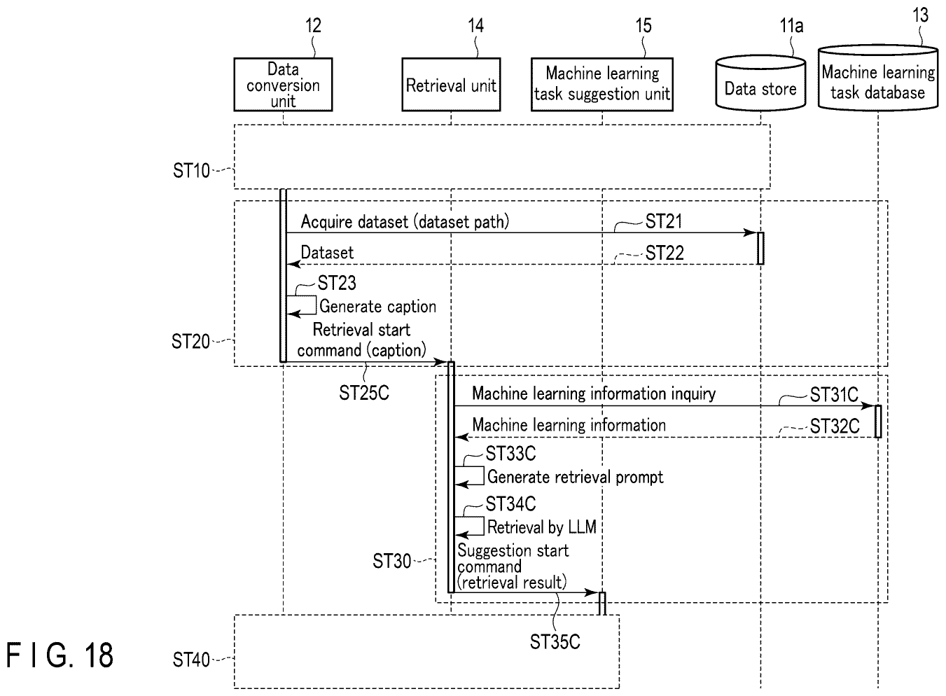

As illustrated in FIG. 17, the machine learning task database 13 stores a candidate of the machine learning task and a description sentence (second data) of the candidate having a common data format in association with each other in advance. The retrieval unit 14 generates a retrieval prompt including a caption and retrieves a candidate of a machine learning task using a large-scale language model (LLM) based on the retrieval prompt.

Other configurations are the same as those of the second embodiment.

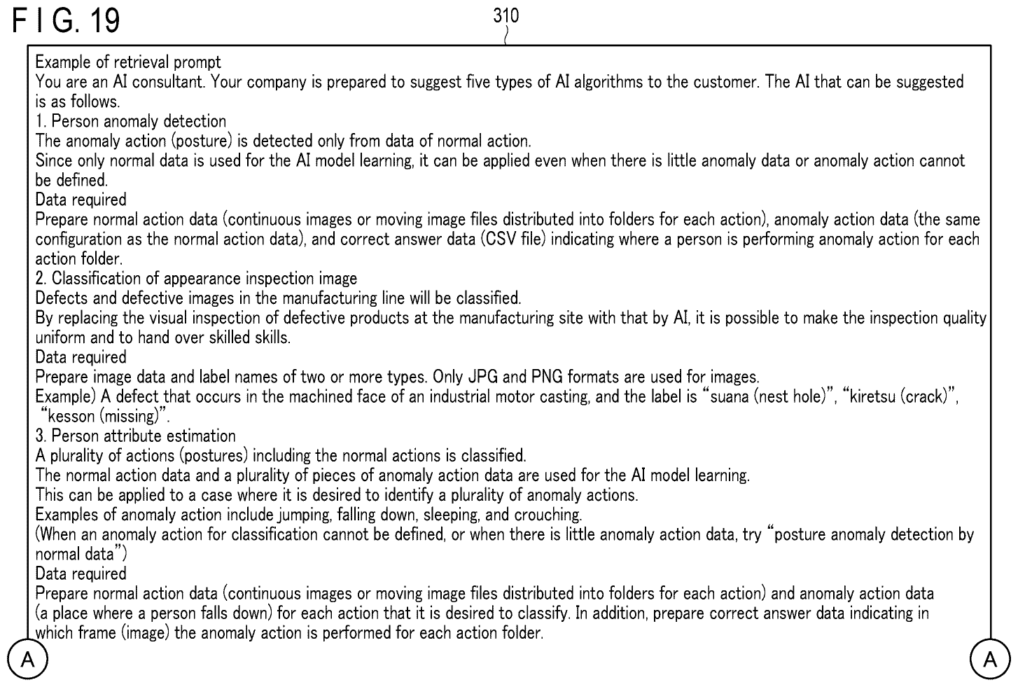

Next, the operation of the machine learning utilization support apparatus configured as described above will be described using the sequence diagram of FIG. 18 and the schematic diagrams of FIGS. 19 to 21. In the following description, among steps ST10 to ST40 described above, steps ST20 to ST30 different from those in the second embodiment will be described using more detailed steps.

Now, step ST10 is executed in the same manner as described above.

### (Step ST20)

Steps ST21 to ST23 are executed in the same manner as described above, and the caption describing each sample of the user dataset 200 in a text format are generated.

After step ST23, the data conversion unit 12 transmits a retrieval start command including a caption to the retrieval unit 14 (step ST25C). Accordingly, step ST20 ends.

### (Step ST30)

Upon receiving the retrieval start command, the retrieval unit 14 transmits a machine learning information inquiry for acquiring a pair of a machine information task and a description sentence to the machine learning task database 13 (step ST31C). Thereafter, the retrieval unit 14 acquires machine learning information including a pair of the machine learning task and the description sentence from the machine learning task database 13 (step ST32C).

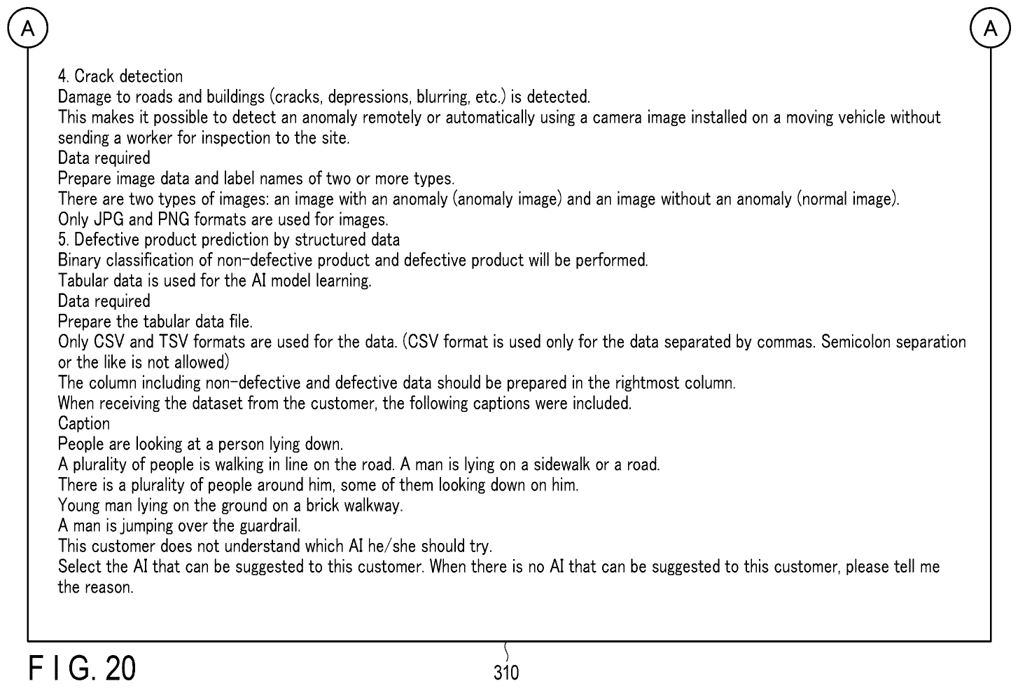

After step ST32C, as illustrated in FIGS. 19 and 20, the retrieval unit 14 generates a retrieval prompt 310 including the caption extracted from the retrieval start command (step ST33C).

The retrieval prompt 310 may be generated by combining a caption and a description of a machine learning task. The description of the machine learning task may include a description registered in advance in the machine learning task database 13 in the retrieval prompt 310, or the machine learning task may be retrieved based on the machine learning task described by the LLM. Examples of the LLM include OpenAI API (GPT) provided by OpenAI, and Google AI PaLM2-Google AI (PaLM) provided by Google. These LLMs may be used, fine tuning may be performed, or an LLM model that has learned from the beginning may be used without using these LLMs.

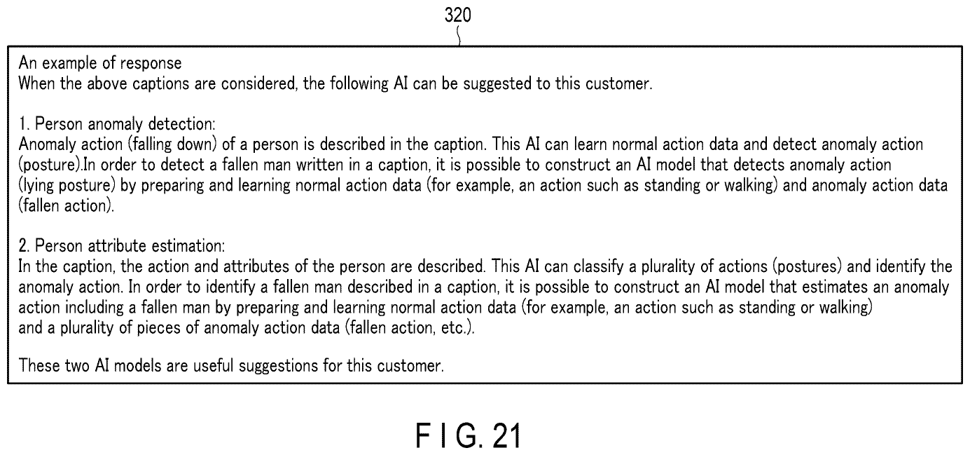

After step ST33C, the retrieval unit 14 retrieves a candidate of the machine learning task from the machine learning information acquired in step ST32C using the large-scale language model (LLM) based on the retrieval prompt 310 (step ST34C). As a result, the retrieval unit 14 acquires a response 320 as illustrated in FIG. 21.

After step ST34C, the retrieval unit 14 transmits a suggestion start command including the response 320 including the candidate retrieval result 300 and the candidate description sentence as the retrieval result to the machine learning task suggestion unit 15 (step ST35C). Accordingly, step ST30 ends.

Thereafter, step ST40 is executed in the same manner as described above.

As described above, according to the seventh embodiment, the common data format is a text format. The data conversion unit 12 generates a caption describing each sample of the user dataset 200 in a text format as the first data. The retrieval unit 14 generates a retrieval prompt 310 including a caption, and retrieves a candidate of a machine learning task using the large-scale language model based on the retrieval prompt 310. Therefore, in addition to the effects described above, generalizability in a case where an unknown dataset is uploaded can be improved. That is, it is possible to suggest, to the user, a machine learning task closer to the thought of the expert of machine learning than the vector retrieval according to the third to sixth embodiments.

### Eighth Embodiment

The machine learning utilization support apparatus according to the eighth embodiment will be described.

The eighth embodiment is a modification of the seventh embodiment, and is an example of a case of performing retrieval using a summary prompt.

Here, the common data format is a text format.

The data conversion unit 12 generates a caption describing each sample of the user dataset 200 in a text format as the first data.

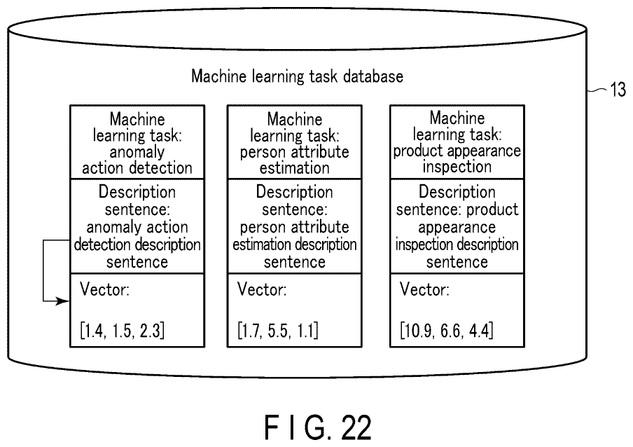

As illustrated in FIG. 22, the machine learning task database 13 stores a candidate of the machine learning task and second data having a common data format and related to the description of the candidate in association with each other in advance. The second data includes a description sentence related to the description of the candidate and a fixed length vector obtained by converting the description sentence. Note that, in the machine learning task database 13, a description sentence of the machine learning task may be prepared in advance, and the machine learning task database may hold a vectorized text using text-to-vec that vectorizes the text. The description sentence may be prepared in the form of pdf, word, or html, and a large text may be divided into small chunks (paragraphs or sentences) by text-to-vec.

The retrieval unit 14 generates a summary prompt including a caption, summarizes the user dataset 200 using the large-scale language model based on the summary prompt, and retrieves a candidate of a machine learning task from the machine learning task database 13 by vector similarity retrieval using the large-scale language model based on the summarized result.

Other configurations are the same as those of the seventh embodiment.

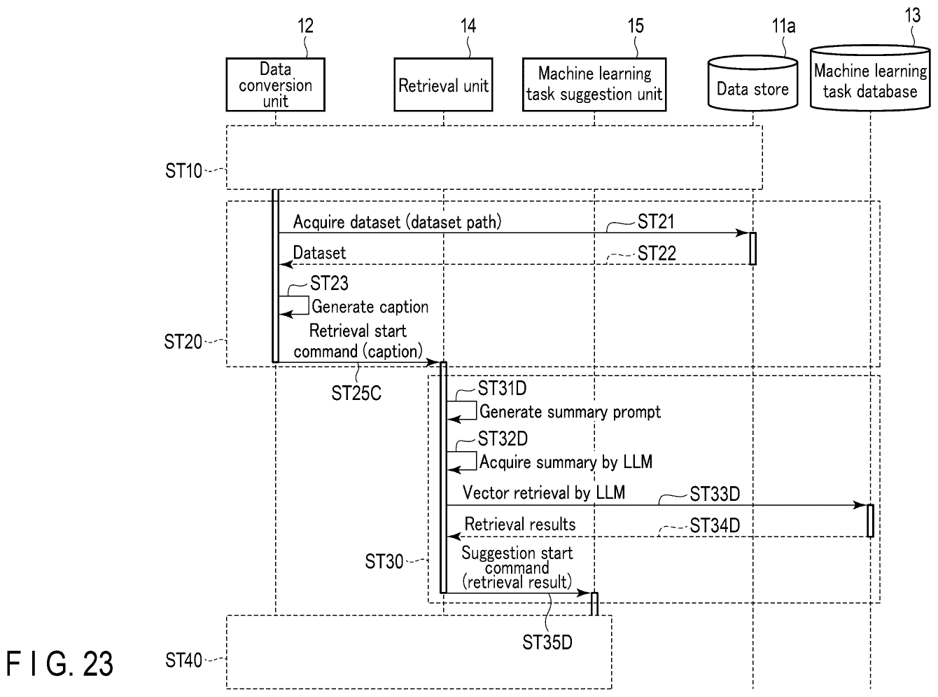

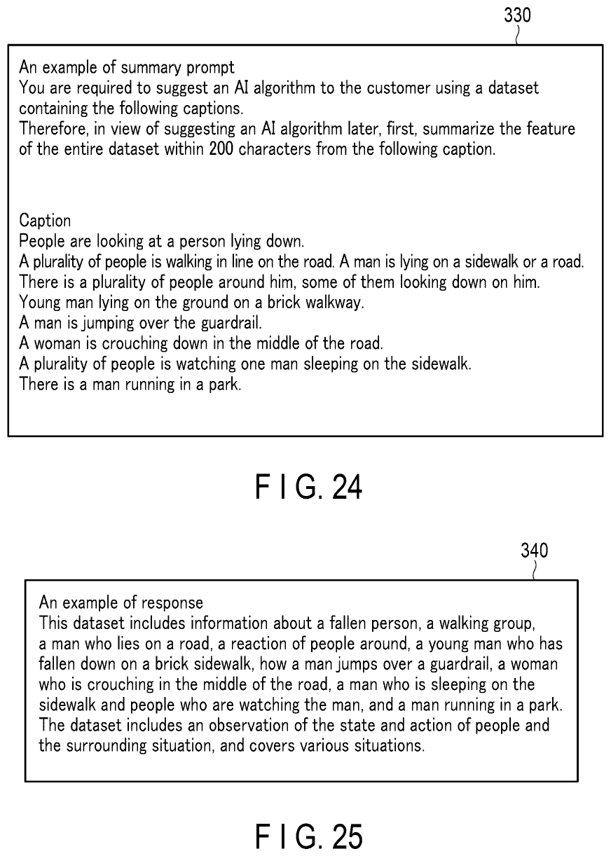

Next, the operation of the machine learning utilization support apparatus configured as described above will be described using the sequence diagram of FIG. 23 and the schematic diagrams of FIGS. 24 and 25. In the following description, among steps ST10 to ST40 described above, steps ST20 to ST30 different from those in the seventh embodiment will be described using more detailed steps.

Now, step ST10 is executed in the same manner as described above.

### (Step ST20)

Steps ST21 to ST23 are executed in the same manner as described above, and the caption describing each sample of the user dataset 200 in a text format are generated.

After step ST23, the data conversion unit 12 transmits a retrieval start command including a caption to the retrieval unit 14 (step ST25C). Accordingly, step ST20 ends.

### (Step ST30)

As illustrated in FIG. 24, the retrieval unit 14 generates a summary prompt 330 including the caption extracted from the retrieval start command (step ST31D). The summary prompt 330 may describe the feature of the entire dataset or may describe the feature using part thereof. Furthermore, words that limit the number of characters to be output may or may not be included in the summary prompt 330.

After step ST31D, the retrieval unit 14 acquires a summary of the user dataset 200 by the large-scale language model (LLM) based on the summary prompt 330 (step ST32D). As a result, as illustrated in FIG. 25, the retrieval unit 14 acquires a response 340 which is a result of summarizing the user dataset 200.

After step ST32D, the retrieval unit 14 retrieves the candidate of the machine learning task from the machine learning task database 13 by vector similarity retrieval using the large-scale language model based on the response 340, and obtains the retrieval result including the retrieval result 300 of the candidate and description sentences of the candidate (steps ST33D to ST34D).

After step ST34D, the retrieval unit 14 transmits a suggestion start command including the retrieval result including the retrieval result 300 of the candidate and the description sentence of the candidate to the machine learning task suggestion unit 15 (step ST35D). Accordingly, step ST30 ends.

Thereafter, step ST40 is executed in the same manner as described above.

As described above, according to the eighth embodiment, the common data format is a text format. The data conversion unit 12 generates a caption describing each sample of the user dataset 200 in a text format as the first data. The retrieval unit 14 generates a summary prompt 330 including a caption, summarizes the user dataset 200 using the large-scale language model based on the summary prompt 330, and retrieves a candidate of a machine learning task from the machine learning task database 13 by vector similarity retrieval using the large-scale language model based on the summarized result. Therefore, in addition to the effects described above, information about the machine learning task can be acquired at a higher speed than in the seventh embodiment by performing vector retrieval. That is, it is possible to shorten the time until the user 1 receives the suggestion of the candidate of the machine learning task.

Further, according to the eighth embodiment, the machine learning task database 13 stores the machine learning task candidate and second data having a common data format and relating to the description of the candidate in association with each other in advance. The second data includes a description sentence related to the description of the candidate and a fixed length vector obtained by converting the description sentence. That is, according to the configuration including the fixed length vector in which the description sentence is converted in advance, it is possible to perform a vector retrieval during the retrieval, without vectorizing the description sentence.

### Ninth Embodiment

Next, the machine learning utilization support apparatus according to the ninth embodiment will be described.

A ninth embodiment is a modification of the seventh embodiment, and is an example of a case where when the user cannot select the retrieved candidate, the candidate is narrowed down using a question prompt.

Here, in addition to the functions described above, in a case where the user is not allowed to select the retrieved candidate, the machine learning task suggestion unit 15 generates a question prompt including an instruction to generate a question for narrowing down the retrieved candidate, generates a question using the large-scale language model based on the question prompt, and generates new suggestion data including a candidate narrowed down from the retrieved candidate and a description of the narrowed candidate based on an answer when an answer of the user 1 to the question is received.

Furthermore, the machine learning task suggestion unit 15 may sequentially narrow down the candidate of the machine learning task by repeatedly generating a question for narrowing down the candidate and generating suggestion data based on an answer of the question.

As the question prompt, a different question may be prepared in a case where the user 1 cannot reselect the machine learning task when the user 1 reselects the machine learning task. Furthermore, the question prompt may include the content of the retrieval result. The retrieval result may include a description of a task in the machine learning task database 13, and the description of the machine learning task may not be included in the prompt but may be considered by the LLM itself. The number of tokens to be transmitted to the LLM may or may not be limited.

The question prompt may be generated based on the retrieval result. The question prompt may also include an instruction to generate a question that selects a positive answer or a negative answer. That is, the output format may or may not be designated in the question prompt. In the case of designating the output format, a JSON format, a list format, or the like can be considered.

The question prompt may include an instruction to generate a question required to select a candidate. That is, the question prompt may or may not generate a question necessary for selecting a machine learning task. However, from the viewpoint of reducing the load on the user, it is preferable that the question prompt generates a question necessary for selecting the machine learning task (does not ask a meaningless question). In this case, for example, in a case where “person anomaly detection”, “crack detection”, and “image classification of appearance inspection” are listed as the machine learning task candidate in the retrieval result, a question (is it necessary to detect whether there is an anomaly?etc.) necessary for selecting the machine learning task is generated.

The question prompt may also include an instruction to generate a reason for generating the question. Examples of the reason for generating the question include “it is possible to narrow down the possibility of the person anomaly detection and the crack detection by asking whether it is necessary to detect whether there is an anomaly in the image data”.

Other configurations are the same as those of the seventh embodiment.

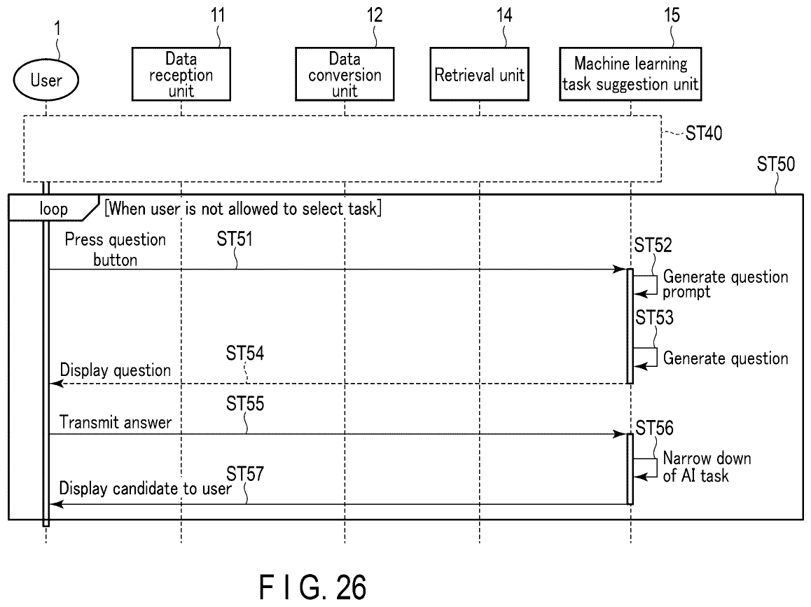

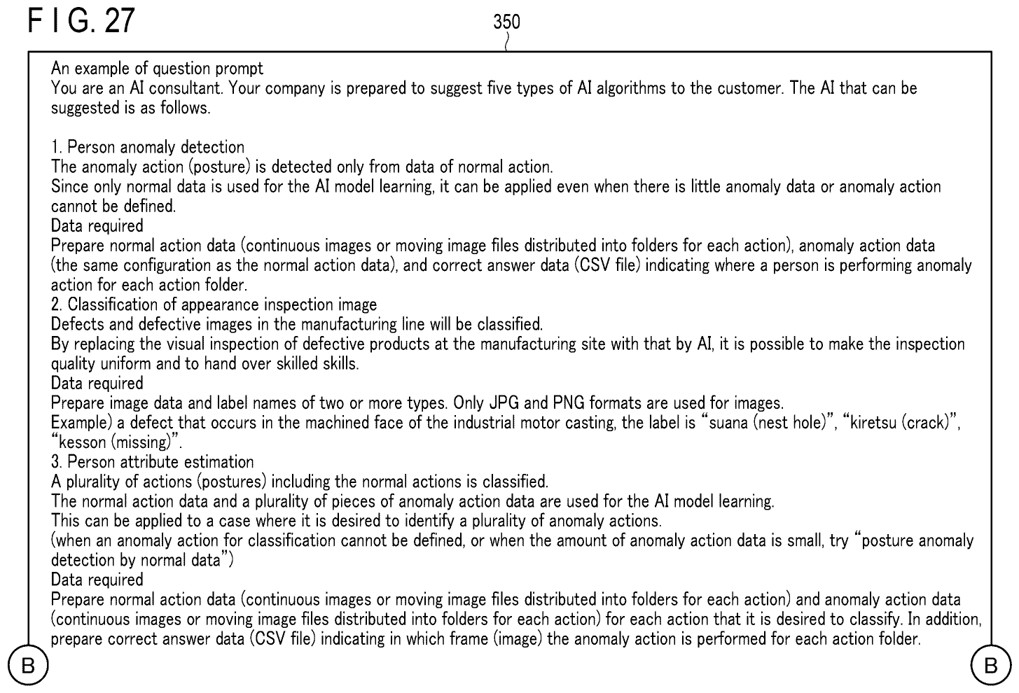

Next, the operation of the machine learning utilization support apparatus configured as described above will be described using the sequence diagram of FIG. 26 and the schematic diagrams of FIGS. 27 to 29. In the following description, after steps ST10 to ST40 described above, step ST50 different from those in the seventh embodiment will be described using more detailed steps.

Now, steps ST10 to ST40 are executed in the same manner as described above. As a result, the machine learning task suggestion unit 15 presents the candidate of the machine learning task together with the description by displaying the task selection support display unit 16a based on the suggestion data and the user dataset 200 on the display unit 16. Here, when the user 1 is not allowed to select a machine learning task, step ST50 is started.

### (Step ST50)

When the question button is pressed down by the operation by the user 1, the GUI of the task selection support display unit 16a transmits an instruction to generate a question prompt to the machine learning task suggestion unit 15 (step ST51).

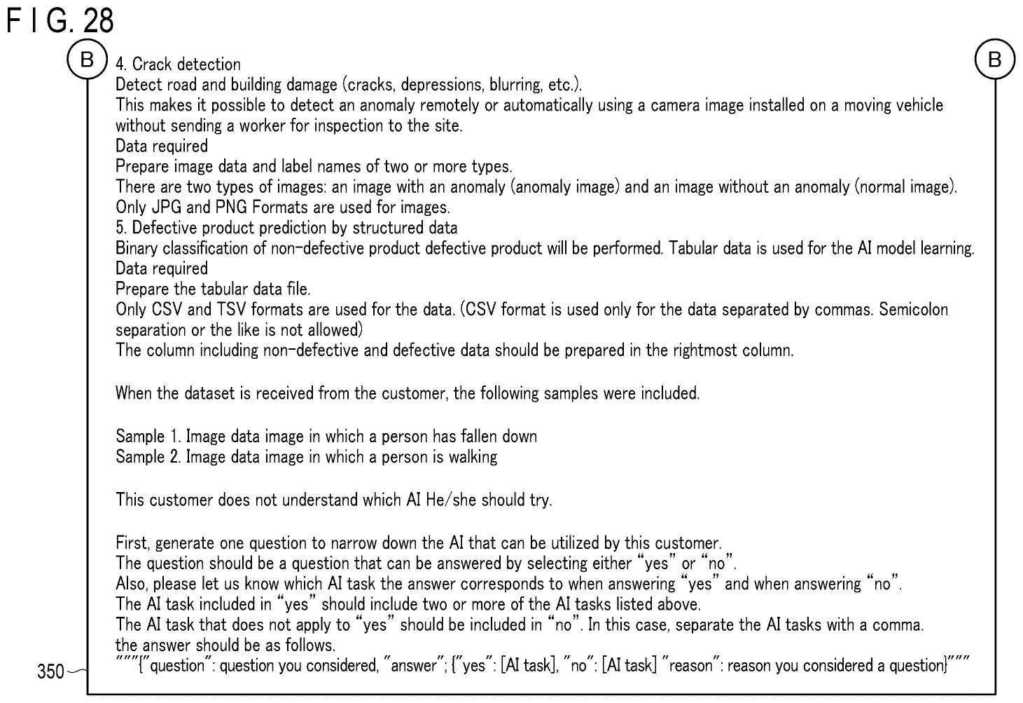

Upon receiving the instruction to generate a question prompt, the machine learning task suggestion unit 15 generates a question prompt 350 including an instruction to generate a question for narrowing down the retrieved candidate as illustrated in FIGS. 27 and 28 (step ST52).

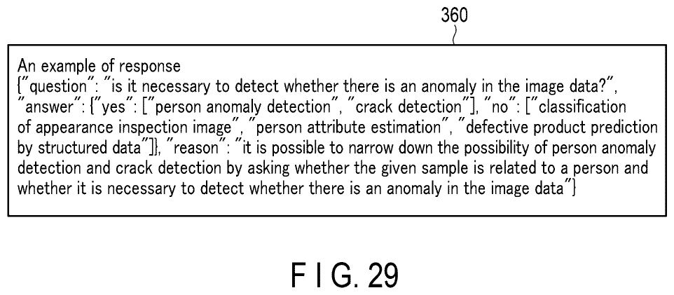

After step ST52, as illustrated in FIG. 29, the machine learning task suggestion unit 15 generates a question 360 using the large-scale language model based on the question prompt 350 (step ST53). Furthermore, the machine learning task suggestion unit 15 causes the display unit 16 to display the question 360 (step ST54).

After step ST54, upon receiving the answer of the user 1 to the question 360, the machine learning task suggestion unit 15 narrows down the candidate of the machine learning task based on the answer (step ST56). In addition, the machine learning task suggestion unit 15 generates new suggestion data including a candidate narrowed down from the retrieved candidate and a description of the narrowed down candidate. Thereafter, the machine learning task suggestion unit 15 presents the candidate of the machine learning task together with the description by displaying the task selection support display unit 16a based on the suggestion data and the user dataset 200 on the display unit 16. As a result, the user 1 selects an appropriate machine learning task based on the suggestion content.

Note that, in a case where the user is not allowed to select the candidate again, the machine learning task suggestion unit 15 may sequentially narrow down the candidate of the machine learning task by repeatedly generating a question for narrowing down the candidate and generating suggestion data based on an answer of the question.

As described above, according to the ninth embodiment, in a case where the user is not allowed to select the retrieved candidate, the machine learning task suggestion unit 15 generates a question prompt 350 including an instruction to generate a question for narrowing down the retrieved candidate, generates the question 360 using the large-scale language model based on the question prompt 350, and generates new suggestion data including a candidate narrowed down from the retrieved candidate and a description of the narrowed candidate based on an answer when an answer of the user 1 to the question 360 is received. Therefore, in addition to the candidate described above, it is possible to reduce the possibility that the user 1 is not allowed to select the machine learning task. In addition, as an advantage of allowing the LLM to prepare a question, generalization is improved as compared with the rule-based question, and it is necessary to consider a question when it is desired to add a machine learning task in the case of the rule-based question, whereas it is easy to add a task in the case of the LLM.

Furthermore, according to the ninth embodiment, the machine learning task suggestion unit 15 may sequentially narrow down the candidate of the machine learning task by repeatedly generating a question for narrowing down the candidate and generating suggestion data based on an answer to the question. In this case, the possibility that the user 1 is not allowed to select the machine learning task can be further reduced.

Also, according to the ninth embodiment, the question prompt 350 may include an instruction to generate the question 360 for selecting a positive answer or a negative answer. For example, by setting the question 360 to a form of answer with “Yes” or “No”, even a user who is not familiar with technology can select a machine learning task.

Further, according to the ninth embodiment, the question prompt 350 may include an instruction to generate the question 360 necessary for selecting a candidate. In this case, the generated questions are limited to those necessary for selecting the machine learning task, and the user does not need to answer meaningless questions.

Further, according to the ninth embodiment, the question prompt may include an instruction to generate a reason for generating the question. In this case, it is possible not only to ask a question but also to tell the user why the question has been made, which has an effect of making it easier for the user to grasp the intention of the question.

### Tenth Embodiment

Next, the machine learning utilization system according to the tenth embodiment will be described.

The tenth embodiment is a modification of the first to ninth embodiments, and is an example of a case where a machine learning model evaluation apparatus capable of communicating with the machine learning utilization support apparatus 10 is further included.

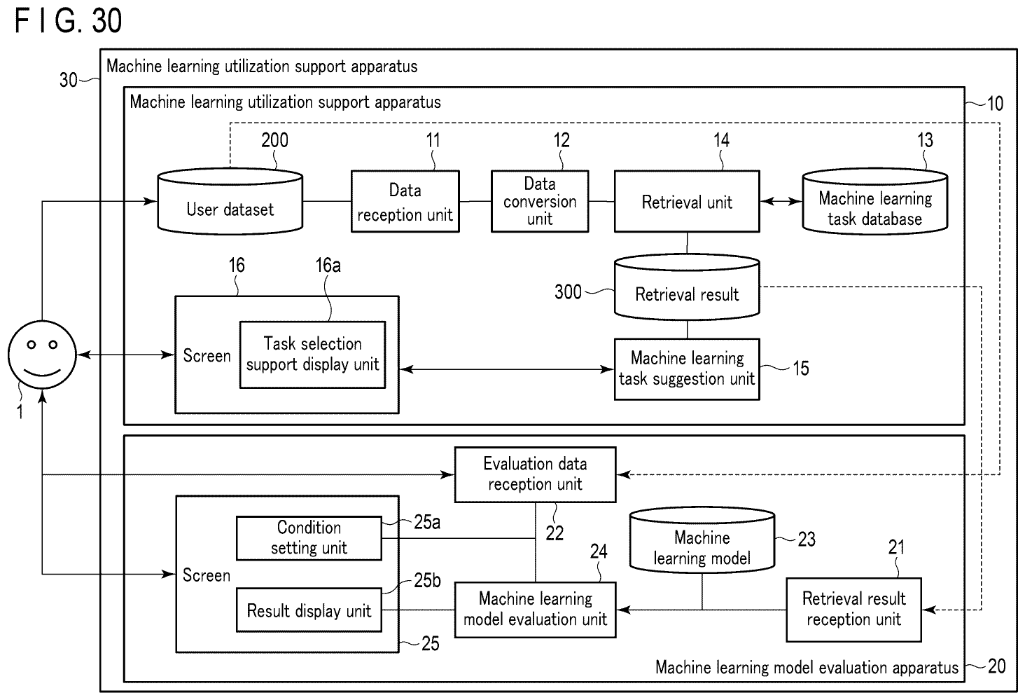

FIG. 30 is a block diagram illustrating an example of a configuration of the machine learning utilization system according to the tenth embodiment. A machine learning utilization system 30 includes the machine learning utilization support apparatus 10 described above and a machine learning model evaluation apparatus 20.

Here, the machine learning model evaluation apparatus 20 includes a retrieval result reception unit 21, an evaluation data reception unit 22, a machine learning model 23 stored in a memory, a machine learning model evaluation unit 24, and a display unit 25.

The retrieval result reception unit 21 receives the retrieval result 300 by the retrieval unit 14.

The evaluation data reception unit 22 receives the user dataset 200 for evaluating machine learning.

The machine learning model 23 is a learned model that has learned in advance. The learned model may be a model prepared for each machine learning task, or may be a base model capable of supporting a plurality of tasks.

In a case where there is a learned model related to the machine learning task corresponding to the received retrieval result, the machine learning model evaluation unit 24 evaluates the learned model based on the user dataset 200 that performs evaluation and the received retrieval result 300.

The display unit 25 displays a condition input unit 25a that is a GUI and receives a condition input for evaluation of machine learning. The display unit 25 displays the evaluation result of the learned model on a result display unit 25b.

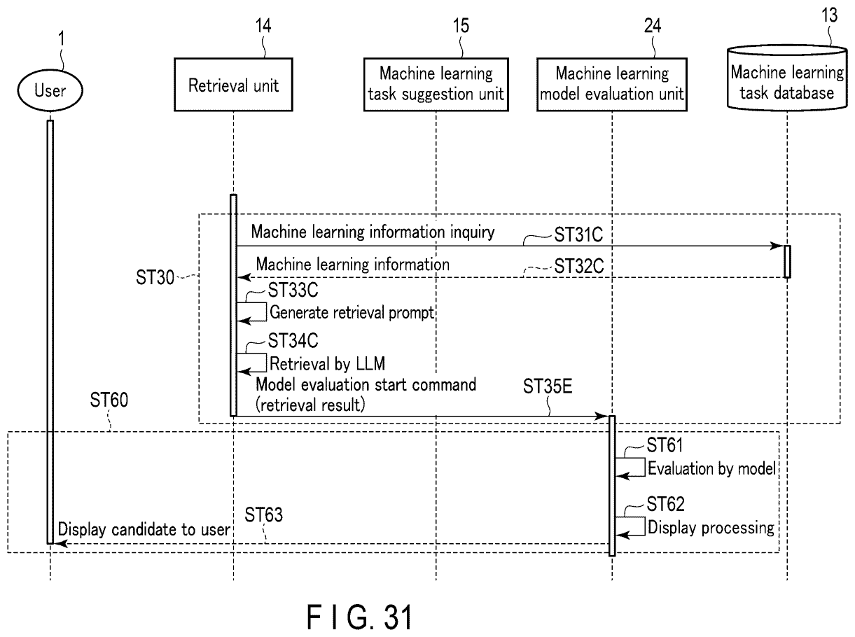

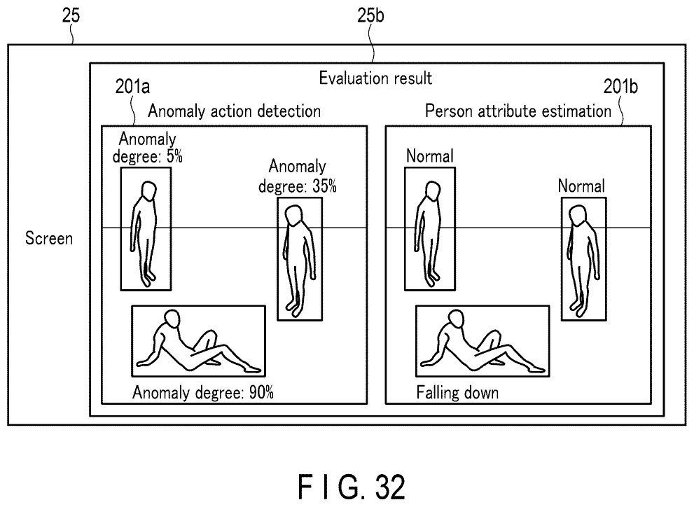

Next, the operation of the machine learning utilization system configured as described above will be described using the sequence diagram of FIG. 31 and the schematic diagram of FIG. 32. In the following description, among steps ST10 to ST40 described above, steps ST30 and subsequent steps different from those in the seventh embodiment will be described using more detailed steps.

Now, steps ST10 to ST20 are executed in the same manner as described above.

### (Step ST30)

Furthermore, steps ST31C to ST34C are executed in the same manner as described above, and the retrieval unit 14 obtains the retrieval result 300 of the candidate of the machine learning task.

After step ST34C, the retrieval unit 14 transmits a model evaluation start command including the candidate retrieval result 300 to the machine learning model evaluation unit 24 via the retrieval result reception unit 21 (step ST35E). Accordingly, step ST30 ends.

### (Step ST60)

In a case where there is a learned model related to the machine learning task corresponding to the received retrieval result, the machine learning model evaluation unit 24 evaluates the learned model based on the user dataset 200 that performs evaluation and the received retrieval result 300 (step ST61).

After step ST61, the machine learning model evaluation unit 24 performs display processing of creating display data including an evaluation result (step ST62).

After step ST62, the machine learning model evaluation unit 24 displays the evaluation result on the result display unit 25b of the display unit 25 based on the display data as illustrated in FIG. 32 (step ST63). Here, the result display unit 25b displays sample output images 201a and 201b when the image 201 in the user dataset 200 is input to the learned model related to the machine learning task. As a result, the evaluation result can be indicated to the user.

As described above, according to the tenth embodiment, the machine learning model is a learned model that has learned in advance. In a case where there is a learned model related to the machine learning task corresponding to the received retrieval result, the machine learning model evaluation unit 24 evaluates the learned model based on the user dataset 200 that performs evaluation and the received retrieval result 300. The display unit 25 displays the evaluation result of the learned model. Therefore, a result of actual evaluation can be automatically obtained, and can be used as an index when the user selects a task. That is, since the user can expect a learning result to some extent, it is possible to determine a task that cannot be expected to have good accuracy, and it is easy to remove the task from the choices.

### Modification

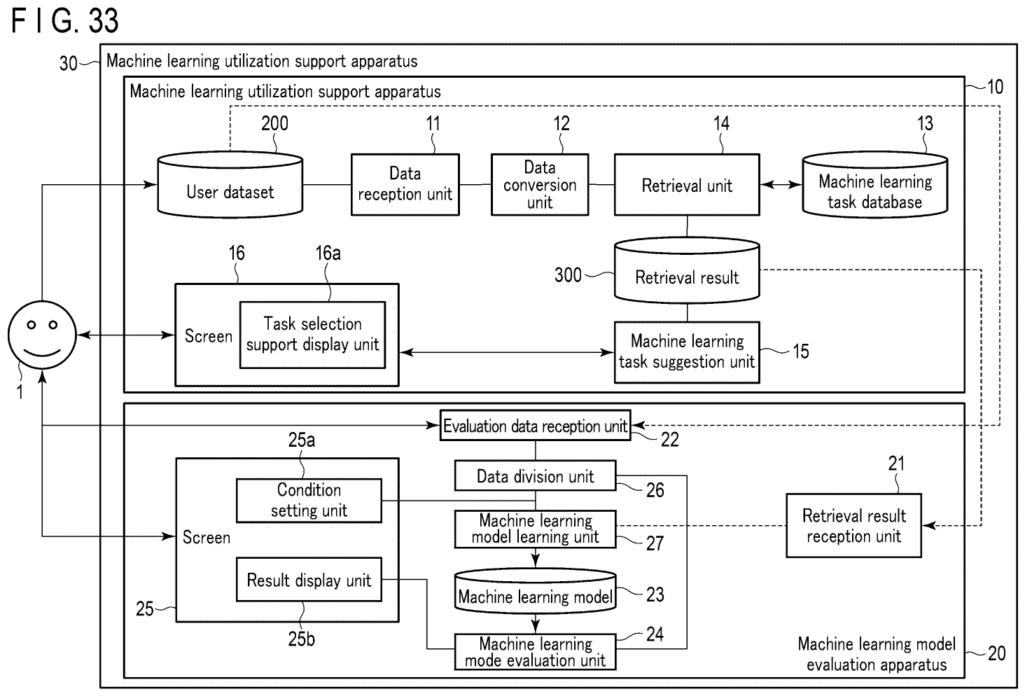

In the tenth embodiment, the case where there is a learned model related to the machine learning task corresponding to the received retrieval result is described, but the present invention is not limited thereto. For example, a configuration in which learning can be performed in a case where there is no machine learning model related to the machine learning task corresponding to the received retrieval result may be used. As illustrated in FIG. 33, this modification further includes a data division unit 26 and a machine learning model learning unit 27 as compared with the configuration illustrated in FIG. 31. Here, in a case where there is no machine learning model related to the machine learning task corresponding to the received retrieval result, the data division unit 26 divides the user dataset 200 that performs evaluation into the first dataset and the second dataset. The machine learning model learning unit 27 causes the machine learning model to train related to the machine learning task based on the first dataset. The machine learning model evaluation unit 24 evaluates the machine learning model obtained by training based on the second dataset. The display unit 25 displays the evaluation result of the machine learning model. Therefore, in the conventional AutoML system, training cannot be executed unless a machine learning task is selected, whereas, according to this modification, it is possible to retrieve a task that can be learned only by uploading a dataset and automatically execute training. That is, even a non-expert of machine learning can easily execute training.

### Eleventh Embodiment

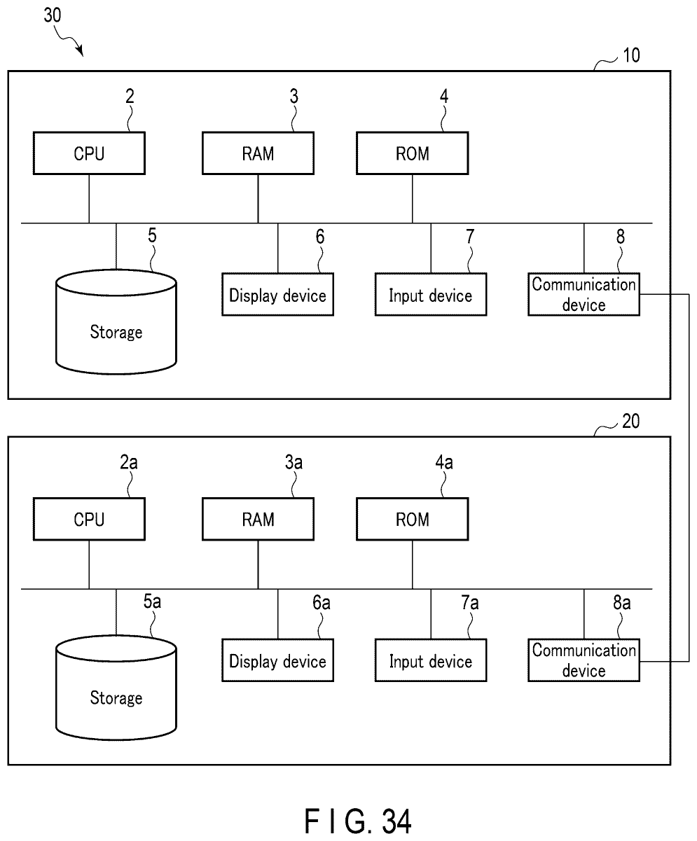

FIG. 34 is a block diagram illustrating an example of a hardware configuration of a machine learning utilization support system according to the eleventh embodiment. The eleventh embodiment is a specific example of the first to tenth embodiments, and has a form in which each of the machine learning utilization support apparatus 10 and the machine learning model evaluation apparatus 20 is realized by a computer.

Each of the machine learning utilization support apparatus 10 and the machine learning model evaluation apparatus 20 includes a central processing unit (CPU) 2, 2a, a random access memory (RAMs) 3, 3a, a read only memory (ROMs) 4, 4a, a storage 5, 5a, a display device 6, 6a, an input device 7, 7a, and a communication device 8, 8a that are connected by a bus. Note that the components of the machine learning utilization support apparatus 10 may be referred to by adding “first”, such as the first CPU, the first RAM, the first ROM, the first storage, the first display device, the first input device, and the first communication device, for example. Similarly, the components of the machine learning model evaluation apparatus 20 may be referred to by adding “second”. The present invention is not limited thereto, and the components of each of the apparatuses 10 and 20 may be referred to by any names different from each other.

The CPU 2, 2a is a processor that executes arithmetic processing, control process, and the like according to a program. The CPU 2, 2a uses a predetermined area of the RAM 3, 3a as a work area, and executes processing of each unit of the machine learning utilization support apparatus 10 and the machine learning model evaluation apparatus 20 described above in cooperation with programs stored in the ROM 4, 4a, the storage 5, 5a, and the like. Each of the CPU 2, 2a and the processor may be referred to as a processing circuit. Each of the CPU 2 and the processor may be referred to as a first processing circuit. Similarly, each of the CPU 2a and its processor may be referred to as a second processing circuit.

The RAM 3, 3a is a memory such as a synchronous dynamic random access memory (SDRAM). The RAM 3, 3a functions as a work area of the CPU 2, 2a.

The ROM 3, 3a is a memory that stores a program and various types of information in a non-rewritable manner.

The storage 5, 5a is a device that writes and reads data to and from a magnetic recording medium such as a hard disc drive (HDD), a semiconductor storage medium such as a flash memory, a magnetically recordable storage medium such as an HDD, an optically recordable storage medium, or the like. The storage 5, 5a writes and reads data to and from the storage medium under the control of the CPU 2, 2a. The storage 5, 5a is an example of a database and a memory of a computer.

The display device 6, 6a is a display such as liquid crystal display (LCD). The display device 6, 6a displays various types of information based on a display signal from the CPU 2, 2a. The display device 6, 6a is an example of a display.

The input device 7, 7a is an input device such as a mouse and a keyboard. The input device 7, 7a receives information input by the operation from the user as an instruction signal, and outputs the instruction signal to the CPU 2, 2a.

The communication device 8, 8a communicates with an external device via a network in accordance with control from the CPU 2, 2a. The communication device 8, 8a may be referred to as a communication circuit.

The instruction illustrated in the processing procedure illustrated in the above-described embodiment can be executed based on a program that is software. By storing this program in advance and reading this program, a general-purpose computer system can obtain an effect similar to the effect by the operation of the machine learning utilization support apparatus 10 and the machine learning model evaluation apparatus 20 described above. The instructions described in the above-described embodiments are recorded in a magnetic disk (flexible disk, hard disk, etc.), an optical disk (CD-ROM, CD-R, CD-RW, DVD-ROM, DVD±R, DVD±RW, Blu-ray (registered trademark) Disc, and the like), a semiconductor memory, or a non-transitory recording medium similar thereto as a program that can be executed by a computer. The storage format may be any form as long as it is a recording medium readable by a computer or an embedded system. The storage medium may be referred to as a non-transitory computer readable storage medium. When the computer reads a program from the recording medium and causes the CPU to execute the instruction described in the program based on the program, it is possible to implement a machine learning utilization support method involving operations similar to the operations of the machine learning utilization support apparatus 10 and the machine learning model evaluation apparatus 20 according to the above-described embodiment. Of course, in a case where the computer acquires or reads the program, the program may be acquired or read through a network.

In addition, an operating system (OS) running on a computer, database management software, middleware (MW) such as a network, or the like based on an instruction of a program installed from a recording medium to the computer or an embedded system may execute part of each process for realizing the present embodiment.

Furthermore, the recording medium in the present embodiment is not limited to a medium independent of a computer or an embedded system, and includes a recording medium that downloads and stores or temporarily stores a program transmitted via a LAN, the Internet, or the like.

Furthermore, the number of recording media is not limited to one, and a case where the processing in the present embodiment is executed from a plurality of media is also included in the recording media in the present embodiment, and the configuration of the media may be any configuration.

Note that the computer or the embedded system in the present embodiment is for executing each processing in the present embodiment based on a program stored in a recording medium, and may have any configuration such as an apparatus including one of a personal computer, a microcomputer, and the like, a system in which a plurality of apparatuses is connected to a network, and the like.

In addition, the computer in the present embodiment is not limited to a personal computer, and includes an arithmetic processing device, a microcomputer, and the like included in an information processing device, and collectively refers to an apparatus and a device capable of realizing a function in the present embodiment by a program.

### Modification of Each Embodiment

Note that each embodiment and each modification may be expressed as a method or a program including each step of the machine learning utilization support apparatus 10 and the machine learning model evaluation apparatus 20 described above.

According to at least one embodiment described above, even a non-expert of machine learning can select an appropriate machine learning task based on data to be processed. The same applies to at least one modification described above.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A machine learning utilization support apparatus comprising:
a database that stores a candidate of a machine learning task and second data having a common data format and related to a description of the candidate in association with each other in advance; and
a first processing circuit configured to
receive a dataset to be processed of a machine learning task,
convert each sample of the dataset to first data in the common data format,
retrieve a candidate of a machine learning task associated with the second data corresponding to the first data in the database based on the first data, and
generate suggestion data including a candidate of the machine learning task and a description of the candidate based on a retrieval result of the candidate.

2. The machine learning utilization support apparatus according to claim 1, further comprising: a first display that displays a candidate of a machine learning task included in the suggestion data and a description of the candidate.

3. The machine learning utilization support apparatus according to claim 1, wherein
the common data format is a text format,
the second data is the candidate keyword, and
the first processing circuit is configured to
generate a caption describing each sample of the dataset in the text format, count the number of appearances of words included in the caption, set a word having a relatively large number of appearances as the first data, and
retrieve a candidate of the machine learning task from the database by a keyword retrieval based on the word that is the first data.

4. The machine learning utilization support apparatus according to claim 1, wherein
the common data format is a vector format,
the first processing circuit is configured to convert each sample of the dataset into a first fixed length vector that is the first data,
the second data is a second fixed length vector obtained by converting a description of the candidate, and
the first processing circuit is configured to retrieve a candidate of the machine learning task by a vector similarity retrieval between the first fixed length vector and the second fixed length vector.

5. The machine learning utilization support apparatus according to claim 4, wherein
the dataset is a set of image data, and
the first processing circuit is configured to generate a caption describing each sample of the dataset in a text format, and convert the caption into the first fixed length vector.

6. The machine learning utilization support apparatus according to claim 4, wherein
the dataset is a set of tabular data, and
the first processing circuit is configured to generate a caption describing a feature of the dataset in a text format based on a file name, a header character string, and a statistic of each column of each sample of the dataset, and convert the caption into the first fixed length vector.

7. The machine learning utilization support apparatus according to claim 4, wherein
the dataset is a set of time series data, and
the first processing circuit is configured to generate a caption describing a feature of the dataset in a text format based on a file name, a series name, and a statistic for each series of each sample of the dataset, and convert the caption into the first fixed length vector.

8. The machine learning utilization support apparatus according to claim 4, wherein
the dataset is a set of multimodal data including tabular data and time series data, and
the first processing circuit is configured to generate a caption describing a feature of the dataset in a text format based on a file name, a data format, and a header character string included in the dataset, and convert the caption into the first fixed length vector.

9. The machine learning utilization support apparatus according to claim 1, wherein
the common data format is vector data,
the first processing circuit is configured to convert each sample of the dataset into a first fixed length vector that is the first data, and estimates a first domain of the dataset based on the first fixed length vector,
the database stores a candidate of the machine learning task, a second domain of the candidate, and the second data in association with each other,
the second data is a second fixed length vector obtained by converting a description of the candidate, and
the first processing circuit is configured to retrieve a candidate of the machine learning task based on the first domain and the first fixed length vector.

10. The machine learning utilization support apparatus according to claim 1, wherein
the common data format is a text format, and
the first processing circuit is configured to
generate a caption describing each sample of the dataset in a text format as the first data,
generate a retrieval prompt including the caption, and retrieve a candidate of the machine learning task using a large-scale language model based on the retrieval prompt.

11. The machine learning utilization support apparatus according to claim 1, wherein
the common data format is a text format, and
the first processing circuit is configured to
generate a caption describing each sample of the dataset in a text format as the first data,
generate a summary prompt including the caption, summarize the dataset using a large-scale language model based on the summary prompt, and retrieve a candidate of the machine learning task from the database by a vector similarity retrieval using a large-scale language model based on the summarized result.

12. The machine learning utilization support apparatus according to claim 11, wherein
the database stores a candidate of a machine learning task and second data having the common data format and related to a description of the candidate in association with each other in advance, and
the second data includes a description sentence related to the description of the candidate and a fixed length vector obtained by converting the description sentence.

13. The machine learning utilization support apparatus according to claim 10, wherein the first processing circuit is configured to generate a question prompt including an instruction to generate a question for narrowing down the retrieved candidate in a case where a user is not allowed to select the retrieved candidate, generate the question using a large-scale language model based on the question prompt, and generate new suggestion data including a candidate narrowed down from the retrieved candidate and a description of the narrowed candidate based on the answer when an answer of the user to the question is received.

14. The machine learning utilization support apparatus according to claim 13, wherein the first processing circuit is configured to sequentially narrow down a candidate of the machine learning task by repeatedly generating a question for narrowing down the candidate and generating suggestion data based on an answer to the question.

15. The machine learning utilization support apparatus according to claim 14, wherein the question prompt includes an instruction to generate a question for selecting a positive answer or a negative answer.

16. The machine learning utilization support apparatus according to claim 14, wherein the question prompt includes an instruction to generate a question necessary for selection of the candidate.

17. The machine learning utilization support apparatus according to claim 14, wherein the question prompt includes an instruction to generate a reason for generating the question.

18. A machine learning utilization system comprising:
the machine learning utilization support apparatus according to claim 1; and
a machine learning model evaluation apparatus capable of communicating with the machine learning utilization support apparatus, wherein
the machine learning model evaluation apparatus includes
a second processing circuit configured to
receive the retrieval result,
receive a dataset for evaluating machine learning,
divide a dataset that performs the evaluation into a first dataset and a second dataset in a case where there is no machine learning model related to a machine learning task corresponding to the received retrieval result,
cause a machine learning model to train related to the machine learning task based on the first dataset, and
evaluate a machine learning model obtained by the learning based on the second dataset, and
a second display that displays an evaluation result of the machine learning model.

19. A machine learning utilization support method comprising:
receiving a dataset to be processed of a machine learning task;
converting each sample of the dataset to first data in a common data format;
storing a candidate of a machine learning task and second data having the common data format and related to a description of the candidate in association with each other in advance;
retrieving a candidate of a machine learning task associated with the second data corresponding to the first data in the database based on the first data; and
generating suggestion data including a candidate of the machine learning task and a description of the candidate based on a retrieval result of the candidate.

20. A non-transitory computer readable storage medium including computer executable instructions, wherein the instructions, when executed by a computer including a memory and a processor, cause the processor to perform a method comprising:
receiving a dataset to be processed of a machine learning task;
converting each sample of the dataset to first data in a common data format;
storing a candidate of a machine learning task and second data having the common data format and related to a description of the candidate in association with each other in the memory in advance;
retrieving a candidate of a machine learning task associated with the second data corresponding to the first data in the memory based on the first data; and
generating suggestion data including a candidate of the machine learning task and a description of the candidate based on a retrieval result of the candidate.
